(19) United States
(12) Patent Application Publication
(10) Pub. No.: US 2021/0224714 A1
(43) Pub. Date: Jul. 22, 2021

(54) FOOD SAFETY PERFORMANCE MANAGEMENT MODELS

(71) Applicant: Ecolab USA Inc., Eagan, MN (US)

(72) Inventors: Joseph P. Erickson, Hastings, MN (US); Shilpa Yelamaneni, Woodbury, MN (US)

(21) Appl. No.: 17/150,947

(22) Filed: Jan. 15, 2021

Related U.S. Application Data
(60) Provisional application No. 62/962,725, filed on Jan. 17, 2020.

(51) Int. Cl. G06Q 10/06; G06Q 50/12; G06Q 50/26

(52) U.S. Cl. CPC G06Q 10/06393; G06Q 10/06375; G06Q 10/0633; G06Q 30/0631; G06Q 50/12; G06Q 50/26; G06Q 10/0635

(57) ABSTRACT

Systems and/or methods that monitor and/or evaluate safety performance for an establishment by analyzing data from one or more data sources to monitor and/or evaluate food safety performance for the food establishment. The one or more data sources may include, for example, health department inspection data, observational data, cleaning machine data, chemical product dispenser data, and/or hand hygiene data. The system/methods may generate one or more scores or ratings indicative of the safety performance of the establishment, or for one or more groups of food establishments. The systems/methods may also generate one or more suggested actions or product recommendations related to the safety performance of the establishment.

This application claims the benefit of U.S. Provisional Application No. 62/962,725, titled, “FOOD SAFETY PERFORMANCE MANAGEMENT MODELS,” filed Jan. 17, 2020, the entire content of which is incorporated herein by reference.

### TECHNICAL FIELD

The disclosure relates to food safety performance management.

### BACKGROUND

Local, state, and federal health regulations require periodic inspections of food establishments, which are designed to reduce the occurrence of foodborne illness such as norovirus, Salmonella, C. perfringens, E. coli, and others. During these inspections, the food establishments are audited against a variety of criteria related to foodborne illness risk factors and good retail practices. These criteria may include, for example, poor personal hygiene, food from unsafe sources, inadequate cooking, improper (hot and/or cold) holding temperatures, contaminated equipment, etc. There are more than 3,000 health department jurisdictions across the United States alone, and among these are varying standards for how inspections should be conducted.

### SUMMARY

In general, the disclosure is directed to systems and/or methods of monitoring and evaluating food safety performance for one or more food establishments.

In one example, the disclosure is directed to a method comprising receiving, by a computing device, food safety data associated with a food establishment from one or more data sources; mapping the food safety data associated with the food establishment to a set of actionable factors; determining, by the computing device, a food safety performance score associated with the food establishment based on the mapped actionable factors associated with the food establishment; determining, by the computing device, a predictive risk associated with the food establishment based on the food safety data from the one or more data sources associated with the food establishment; and generating, for display on a user computing device, an indication of the determined food safety performance score and the determined predictive risk.

The food safety data may include health department inspection data, observational data, cleaning machine data, and chemical product dispenser data associated with the food establishment. The observational data may include observance of structural, sanitation and maintenance conditions of an establishment. The observational data may include self-audit data obtained by employees or the food establishment. The one or more data sources may include a hand hygiene compliance system associated with the food establishment, and the food safety data may include hand hygiene compliance data for the food establishment.

The food safety predictive risk may include a probability that the food establishment will fail an integer number of standardized health department inspection questions. The integer number of standardized health department inspection questions may be an integer between 1 and 10.

The food establishment may have an associated food establishment type, and the food safety performance score may be relative to other food establishments having the same associated food establishment type.

The method may further include generating a notification to a mobile computing device associated with a user recommending at least one of a training procedure or a product recommendation. The method may further include generating, for display on a user computing device, a graphical user interface including at least one of a recommended training procedure or a product recommendation. The product recommendation may include one of a cleaning product or a hand washing product.

In another example, the disclosure is directed to a system comprising one or more data sources associated with a food establishment, the one or more data sources monitor parameters related to food safety performance of the food establishment; a server computing device that receives food safety data from one or more data sources associated with a food establishment, food safety data including monitored parameters related to food safety performance of the food establishment, the server computing device comprising one or more processors; a mapping that relates the food safety data associated with the food establishment to a set of actionable factors; a performance score module including computer readable instructions that, when executed by the one or more processors, cause the one or more processors to determine a food safety performance score associated with the food establishment based on the mapped actionable factors associated with the food establishment; and a predictive risk module including computer readable instructions that, when executed by the one or more processors, cause the one or more processors to determine a predictive risk associated with the food establishment based on the mapped actionable factors associated with the food establishment, wherein the computing devices further generates, for display on a user computing device, an indication of the determined food safety performance score and the determined predictive risk.

The food safety data may include health department inspection data, observational data, cleaning machine data, and chemical product dispenser data associated with the food establishment. The one or more data sources may include a hand hygiene compliance system associated with the food establishment, and the food safety data may include hand hygiene compliance data for the food establishment.

The food safety predictive risk may include a probability that the food establishment will fail an integer number of standardized health department inspection questions. The integer number of standardized health department inspection questions is an integer between 1 and 10.

The method may further include generating a notification to a mobile computing device associated with a user recommending at least one of a training procedure or a product recommendation. The method may further include generating, for display on a user computing device, a graphical user interface including at least one of a recommended training procedure or a product recommendation. The product recommendation may include one of a cleaning product or a hand washing product.

In another example, the disclosure is directed to method comprising during a training phase: receiving at a server computing device, a plurality of data set training pairs, wherein a first data set of each training pair comprises an actionable factor training data set associated with one of a plurality of food establishments, and wherein a second data set of each training pair comprises a standardized health department inspection questions training data set for the same one of the plurality of food establishments; determining, by the server computing device, a plurality of probabilistic classifier parameters based on the plurality of data set training pairs, wherein the probabilistic classifier predicts a probability that a food establishment will fail an integer number of the standardized health department inspection questions; during a prediction phase: receiving, at the probabilistic classifier at the server computing device, a food safety data set associated with a first food establishment; mapping the food safety data set to a set of actionable factors to create an actionable factor data set associated with the first food establishment; determining, by the server computing device, a probability that the first food establishment will fail the integer number of the standardized health department inspection questions based on the actionable factor data set and the plurality of probabilistic classifier parameters; and generating, by the server computing device and for display on a user computing device, an indication of the determined probability.

The integer number of standardized health department inspection questions may be an integer between 1 and 10. The probabilistic classifier may be a random forest classifier. The first data set of each training pair may further include a geospatial training data set associated with the one of the plurality of food establishments. The first food establishment may or may not be one of the plurality of food establishments in the data set training pairs. The indication of the determined probability may include a graphical user interface including the probability that the first food establishment will fail the integer number of standardized health department inspection questions.

In another example, the disclosure is directed to a method comprising obtaining food safety data associated with a food establishment from one or more data sources; mapping the food safety data associated with the food establishment to a set of actionable factors to create an actionable factor data set associated with the food establishment; determining, by providing the actionable factor data set to a trained neural network, a probability that the food establishment will fail an integer number of standardized health department questions; and generating, for display on a user computing device, an indication of the determined probability.

In another example, the disclosure is directed to a method comprising receiving food safety data associated with a food establishment from one or more data sources; mapping the food safety data associated with a food establishment to a set of actionable factors; determining a pass rate for each of the actionable factors for a group of similar food establishments; determining a failure rate for each of the actionable factors for the group of similar food establishments; applying weights to each of the actionable factors associated with the food establishment; and determining a food safety performance score based on the actionable factors associated with the food establishment, the weights, the pass rates and the fail rates.

In another example, the disclosure is directed to a system comprising one or more chemical product dispensers associated with an establishment;

a computing device that receives chemical product dispense event data for a first time frame from the one or more chemical product dispensers; the computing device comprising one or more processors; and a performance score module including computer readable instructions that, when executed by the one or more processors, cause the one or more processors to determine a chemical product dispense event threshold based on the chemical product dispense event data for the first time frame and determine a chemical product performance score associated with the establishment based on the chemical product dispense event threshold and chemical product dispense event data received for the second time frame, wherein the computing devices further generates, for display on a user computing device, an indication of the determined chemical product performance score.

The system may further include a prediction module including computer readable instructions that, when executed by the one or more processors, cause the one or more processors to determine a predicted number of chemical product dispense events for a second time frame that is subsequent to the first time frame, the prediction module further including computer readable instructions that, when executed by the one or more processors, cause the one or more processors to compare the chemical product dispense event data received for the second time with the predicted number of chemical product dispense events for the second time frame, wherein the computing devices further generates, for display on a user computing device, an indication of the result of the comparison between the chemical product dispense event data received for the second time with the predicted number of chemical product dispense events for the second time frame.

In some examples, the one or more chemical product dispensers may include one or more hand hygiene product dispensers. In some examples, the one or more chemical product dispensers may include one or more sanitizer product dispensers. In some examples, the chemical product dispense event data may include a number of dispense events associated with the one or more chemical product dispensers during the first time frame. In some examples, the chemical product dispense event data may include a total on time associated with the one or more chemical product dispenser during the first time frame.

In another example, the disclosure is directed to a system comprising one or more chemical product dispensers associated with an establishment; a computing device that receives chemical product dispense event data for a first time frame from the one or more chemical product dispensers; the computing device comprising one or more processors; and a prediction module including computer readable instructions that, when executed by the one or more processors, cause the one or more processors to determine a predicted number of chemical product dispense events for a second time frame that is subsequent to the first time frame, the prediction module further including computer readable instructions that, when executed by the one or more processors, cause the one or more processors to compare the chemical product dispense event data received for the second time with the predicted number of chemical product dispense events for the second time frame, wherein the computing devices further generates, for display on a user computing device, an indication of the result of the comparison between the chemical product dispense event data received for the second time with the predicted number of chemical product dispense events for the second time frame.

The system may further comprise a performance score module including computer readable instructions that, when executed by the one or more processors, cause the one or more processors to determine a chemical product dispense event threshold based on the chemical product dispense event data for the first time frame and determine a chemical product performance score associated with the establishment based on the chemical product dispense event threshold and chemical product dispense event data received for the second time frame, wherein the computing devices further generates, for display on a user computing device, an indication of the determined chemical product performance score.

The details of one or more examples are set forth in the accompanying drawings and the description below. Other features and advantages will be apparent from the description and drawings, and from the claims.

### BRIEF DESCRIPTION OF DRAWINGS

FIG. 1A is a block diagram illustrating an example environment in which food safety performance may be monitored and evaluated.

FIG. 1B is a block diagram of an example analysis module by which a computing device may monitor and evaluate food safety performance for one or more food establishments.

FIG. 2 is a block diagram illustrating an example food service establishment where food safety performance may be monitored and evaluated.

FIG. 3 is a flowchart illustrating an example process by which a computing device may generate, based on analysis of food safety data from one or more data sources, a food safety performance score and a predictive risk indicator for a selected grouping of food establishments.

FIG. 4 is a screen shot of an example graphical user interface presenting the results of an analysis of food safety data from one or more data sources to monitor and/or evaluate food safety performance for a food establishment.

FIG. 5 is a screen shot of another example graphical user interface presenting the results of an analysis of food safety data from one or more data sources to monitor and/or evaluate food safety performance for the food establishment of FIG. 4.

FIG. 6 is a screen shot of another example graphical user interface presenting the results of an analysis of food safety data from one or more data sources to monitor and/or evaluate food safety performance for an “All Sites” group of food establishments associated with a single corporate entity.

FIG. 7 is a screen shot of another example graphical user interface presenting the results of an analysis of food safety data from one or more data sources to monitor and/or evaluate food safety performance for a “Bottom 5” sub-group of food establishments associated with the single corporate entity of FIG. 6.

FIG. 8 is a screen shot of another example graphical user interface presenting the results of an analysis of food safety data from one or more data sources to monitor and/or evaluate food safety performance for a “Bottom 5” sub-group of food establishments associated with a single corporate entity.

FIG. 9 is a flowchart illustrating an example process by which a computing device(s) may generate a product recommendation in accordance with the techniques of the present disclosure.

FIG. 10 is a flowchart illustrating another example process by which a computing device(s) may generate a product recommendation in accordance with the techniques of the present disclosure.

FIGS. 11A-11B are a flowchart illustrating an example process by which a computing device may generate a predictive risk indicator, or probability that a food establishment will fail an integer number of standardized health department inspection questions on its next health department inspection in accordance with the techniques of the present disclosure.

FIG. 12 is a flowchart illustrating an example process by which a computing device, may generate a performance score based on food safety data from one or more data sources for a food establishment in accordance with the techniques of the present disclosure.

FIG. 13 are graphs illustrating chemical product dispense event data associated with an establishment in accordance with the techniques of the present disclosure.

FIG. 14 are graphs illustrating example chemical product dispense event data associated with an establishment in accordance with the techniques of the present disclosure.

FIG. 15 is a flowchart illustrating an example process by which a computing device may analyze chemical product dispense event data for establishment in accordance with the techniques of the present disclosure.

FIG. 16 is a flowchart illustrating an example process by which a computing device may analyze chemical product dispense event data for establishment in accordance with the techniques of the present disclosure.

### DETAILED DESCRIPTION

In general, the disclosure is directed to systems and/or methods that monitor and/or evaluate food safety performance. As one example, the techniques of the present disclosure may analyze data from one or more data sources to monitor and/or evaluate food safety performance for one or more food establishments. The one or more data sources may include, for example, health department inspection data, observational data, cleaning machine data, chemical product dispenser data, food service machine data, hand hygiene data, and any other data that may be captured or related to food safety performance at a food service establishment. The health department inspection data, observational data, cleaning machine data, chemical product dispenser data, food service machine data, hand hygiene data, and other data may include data associated with or about the food establishment itself and may also include data associated with or about one or more other food establishments.

The techniques of the disclosure may generate, based on analysis of the data from the one or more data sources, one or more scores indicative of the food safety performance of the food establishment. The scores may be generated by individual food establishment (otherwise referred to as a “site”) or across groups of multiple food establishments (multiple “sites”). The scores may also be generated at one or more levels, including an actionable factor level, a site level, a category level, or a data source level.

The techniques of the disclosure may also generate, based on analysis of the data from the one or more data sources, a predictive risk indicator indicative of the probability that a food establishment will fail a predetermined number of standardized health department inspection questions on its next routine health department inspection.

The techniques of the disclosure may further generate, based on analysis of the data from the one or more data sources, one or more recommended actions that may be taken to address identified actionable risk areas. The recommended actions may include one or more product recommendations tailored to address an identified actionable risk area.

For each food establishment, the techniques of the disclosure analyze data from one or more available data sources for the food establishment to monitor and/or evaluate food safety performance for the food establishments. In this way, data imputation (replacing missing values with substituted values) is not needed as only data sources from which data for a particular food establishment is available are used to evaluate food safety performance for that food establishment. This may simplify the analysis and improve computational efficiency (both in terms of speed and power) as data imputation can be computationally expensive. This allows the system to generate performance scores and predictive risks values more quickly.

In addition, food safety performance scores generated for different food establishment using different data sets are comparable. Specifically, the scoring logic accounts for translating the information across different data sets into common units of measurement for food safety management (e.g., mapping food safety data associated with a food establishment from one or more data sources to a set of actionable factors); qualification and calibration of an observed issue based on typical observation failures and passes across the market (e.g., pass rate and fail rate for a group of similar food establishments); and scaling of the risk according to criticality (assigning weights to each of the actionable factors).

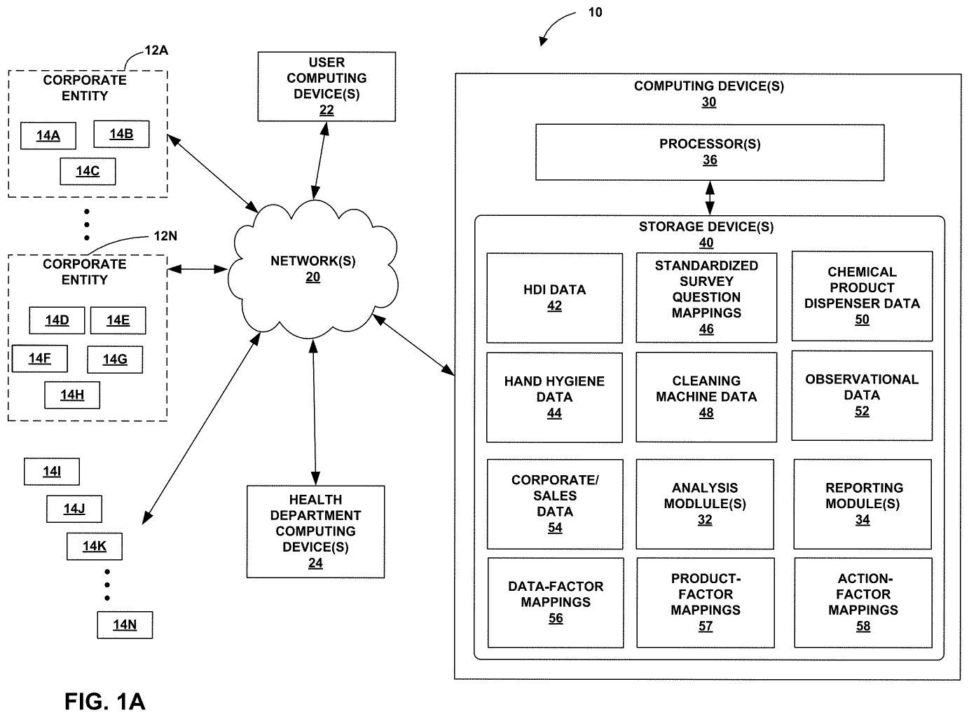

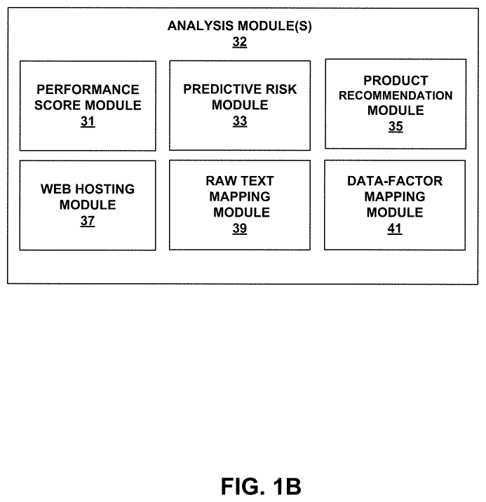

FIG. 1A is a block diagram illustrating an example environment in which food safety performance may be monitored and evaluated. A plurality of food establishments 14A-14N may be located in various cities or states across the country. Food establishments 14A-14N may include any of restaurants, food service facilities, food preparation or packaging facilities, caterers, food transportation vehicles, food banks, etc. Some of the food establishments 14A-14N may be owned, operated, or otherwise associated with one or more corporate entities 12A-12N, such as restaurant “chains.” In FIG. 1, for example, food establishments 14A-14C are associated with corporate entity 12A and food establishments 14D-14H are associated with corporate entity 12N. Some of the food establishments may be stand-alone or individually owned food establishments, such as food establishments 141-14N. It shall be understood that food establishments 14A-14N may include any establishment that that stores, prepares, packages, produces, processes, serves, or sells food for human or animal consumption.

State and local public health departments typically require food establishments to be periodically inspected for compliance with agency standards. The frequency of these inspections varies by jurisdiction, but routine inspections may be required annually, biannually, or at some other periodic interval. Follow-up or investigative inspections may also be required in the event one or more of the standards are not met. At each inspection, an inspection report is prepared which indicates compliance with a variety of foodborne illness risk factors. The format and focus of these inspection reports may vary by jurisdiction.

Server computing device(s) 30 analyze data from one or more data sources to monitor and/or evaluate food safety performance for the one or more food establishments 14A-14N. The data and the results of the analysis may be communicated electronically to corporate entities 12A-12N, food establishments 14A-14N, and/or one or more user computing device(s) 22 via one or more network(s) 20. Network(s) 20 may include, for example, one or more of a dial-up connection, a local area network (LAN), a wide area network (WAN), the internet, a cell phone network, satellite communication, or other means of electronic communication. The communication may be wired or wireless. Server computing device(s) 30 may also, at various times, send commands, instructions, software updates, etc. to one or more corporate entities 12A-12N and/or food establishments 14A-14N via network(s) 20. Server computer 30 may receive data or otherwise communicate with corporate entities 12A-12N, food establishments 14A-14N, user computing device(s) 22 and/or health department computing devices 24 on a periodic basis, in real-time, upon request of server computing device(s) 30, upon request of one or more of corporate entities 12A-12N and/or food establishments 14A-14N, or at any other appropriate time.

The one or more data sources may include data sources from or associated with the food establishment(s) 14A-14N, data sources from or associated with the corporate entities 12A-12N, data sources from or associated with one or more health department(s) 24, and any other data source relevant to monitoring and/or evaluating food safety performance for a food establishment.

Server computing device(s) 30 includes one or more processor(s) 36 and a database 40 or other storage media that stores the various data and programming modules required to monitor and/or evaluate food safety performance for the one or more food establishments 14A-14N. Processor(s) 36 may include one or more general purpose processors (e.g., single core microprocessors or multicore microprocessors) or one or more special purpose processors (e.g., digital signal processors). Processor(s) 36 are operable to execute computer-readable program instructions, such as analysis module 32 and/or reporting module 34. Data storage device(s) 40 may store, for example, health department inspection (HDI) data 42, standardized survey question mappings 46, hand hygiene data 44, cleaning machine data 48, chemical product dispenser data 50, observational data 52, corporate data 54 and any other data relevant to monitoring and evaluation of food safety performance. Data storage device(s) 40 may also store one or more programming modules, such as analysis module(s) 32 and reporting module(s) 34, that, when executed by one or more processor(s) 36, cause server computing device(s) 30 to monitor and/or evaluate food safety performance for the one or more food establishments 14A-14N. Analysis module(s) 32 may include one or more additional modules (see FIG. 1B) for performing various tasks related to monitoring and/or evaluating food safety performance and performance for the one or more food establishments.

HDI data 42 may include health department inspection data obtained at the state or local level during routine or follow-up inspections of food establishments 14A-14N. The individual inspection surveys stored in survey data 42 may be received directly from state and/or local health departments, such as from one or more of health department computing device(s) 24. The HDI data may also be obtained from each food establishment or corporate entity, from a 3^{rd} party, may be obtained online, or may be received in any other manner. HDI data 42 for each individual inspection survey may include, for example, food establishment identification information, state or local agency information, inspection report data information including information concerning compliance with the relevant food safety standards, inspection report date and time stamps, and/or any other additional information gathered or obtained during an inspection.

Hand hygiene data 44 may include data received from a hand hygiene compliance system associated with the food establishment. For example, the hand hygiene compliance system may monitor, analyze and report on hand hygiene compliance at a food service establishment. For example, hand hygiene data 44 may include data from one or more hand hygiene product dispensers associated with the food establishment, such as a record of dispense events, time and date stamps for each dispense event, hand hygiene compliance rules for the food establishment, records of compliant and non-compliant hand hygiene procedures at the food establishment, etc. Additional dispenser information may also be included in the dispenser data, such as dispenser identification information, worker identification information, current battery levels, product bottle presence/absence, a number of dispenser actuations, out-of-product indications, dispenser type, dispensed product name, dispensed product type (e.g., sanitizer, soap, alcohol, etc.), dispensed product form (solid, liquid, powder, pelleted, etc.), dispensed product amounts (by volume, weight, or other measure), dispensing times, dates, and sequences, and any other data relevant to determining hand hygiene compliance.

Example hand hygiene compliance systems and examples of the data that may collected and analyzed are described in U.S. patent application Ser. No. 12/787,064 filed May 25, 2010, U.S. Pat. No. 8,395,515 issued Mar. 12, 2013, U.S. patent application Ser. No. 14/819,349 filed Aug. 15, 2015, U.S. patent application Ser. No. 15/912,999 filed Mar. 6, 2018, U.S. patent application Ser. No. 15/912,999 filed Mar. 6, 2018, and U.S. Pat. No. 10,529,219 issued Jan. 7, 2020, each of which is incorporated by reference in its entirety.

Corporate/sales data 54 may include data that uniquely identifies or is associated with food establishments 14A-14N and/or corporate entities 12A-12N. As such, corporate data 54 may include, for example, food establishment identification information, employee information, management information, accounting information, business information, pricing information, information concerning those persons or entities authorized to access the reports generated by the hand hygiene compliance system, date and time stamps, and any additional information relating to the corporate entity and information specific to each food establishment 14A-14N. Corporate/sales data 54 may further include sales data associated with the food establishments 14A-14N and/or corporate entities 12A-12N. For example, corporate/sales data 54 may include historical sales data concerning product and/or service purchases over time for one or more of food establishments 14A-14N.

Standardized survey question mappings 46 relate the HDI data 42 obtained from state and local jurisdictional inspection reports to a standardized set of health department inspection survey questions. In some examples, the standardized set of survey questions is a set of 54 questions related to foodborne illness risk factors and good retail practices provided by The United States Food and Drug Administration (FDA) in model form 3-A. The 54 questions are presented in a model “Food Establishment Inspection Report” intended to provide a model for state and local agencies to follow when conducting inspections of food establishments. Standardized survey question mappings 46 may relate individual jurisdictional inspection surveys to this standardized set of 54 questions or to another standardized set of survey questions so that inspections from multiple jurisdictions may be compared and contrasted using the same system of measurement. Examples of mappings to a standardized set of survey questions are described in U.S. patent application Ser. No. 13/411,362, filed Mar. 2, 2012, which is incorporated herein by reference in its entirety.

Cleaning machine data 48 may include any data monitored by one or more cleaning machines at the food establishments 14A-14N. The cleaning machines may include any type of cleaning machine typically used at a food establishment that may provide data relevant to monitoring and evaluating food safety performance. Example cleaning machines may include dish machines, sanitizing machines, floor cleaning machines, and any other type of cleaning equipment.

The cleaning machine data 48 received from a dish machine may include, for example, dish machine identification information, a time and date stamp for each cleaning cycle, article types, soil types, and rack volumes, cleaning machine parameters such as wash and rinse water temperatures, wash and rinse cycle time(s) and duration(s), water hardness, pH, turbidity, cleaning solution concentrations, timing for dispensation of one or more chemical products, amounts of chemical products dispensed, and any other data that may be monitored by or received from a dish machine. Cleaning machine data 48 received from a floor cleaning machine may include, for example, floor machine identification information, a time and date stamp for each cleaning cycle, floor types, soil types, coverage information, wash and rinse water temperatures, wash and rinse cycle time(s) and duration(s), water hardness, pH, turbidity, cleaning solution concentrations, timing for dispensation of one or more chemical products, amounts of chemical products dispensed, and any other data that may be monitored by or received from a floor cleaning machine.

Chemical product dispenser data 50 may include any information received from or concerning chemical product dispensers associated with the food establishment. Such chemical product dispensers may include, for example, automated chemical product dispensers that automatically dispense controlled amounts of one or more chemical cleaning products to a dish machine, chemical product dilution dispensers for controlled dispensing of chemical product concentrates into, for example, a bucket or spray bottle, and any other type of chemical product dispenser. Chemical product dispenser data may include dispenser identification information, dispensing times, dates, type of name of chemical product dispensed, employee information, amount of chemical product dispensed, etc.

Observational data 53 may include any information obtained through observation or audits of the food establishment. Such data may include, for example, any observational information relating to proper food safety protocols gathered by an auditor at a food establishment. The observational data may further include observational data gathered by an outside auditor or service technician, and/or may also include self-audit data gathered by one or more employees of the food establishment. The observational data 53 may be entered into a user computing device, such as a laptop computer, tablet computer, or mobile computing device, etc., and transmitted to server computing device 30, where it is stored as observational data 53.

Data-factor mappings 56 include a mapping from each individual data point to one of a plurality of “actionable factors.” In accordance with the present disclosure, the actionable factors were chosen to be those food safety related factors having an associated action that may be taken to address, remedy or correct a failure with respect to that factor. Data-actionable factor mappings may also include weights assigned to each actionable factor associated with the so-called “criticality” or relative importance of that actionable factor when evaluating food safety performance. Example data-actionable factor mappings are shown in Table 1.

TABLE 1

| | | Sub- | | |
|---|---|---|---|---|
| Data Source | Category | Category | Actionable Factor | Weight |
| Connected Controller | Contamination | Warewashing | DetergentOOP-AM | 4 |
| Connected Controller | Contamination | Warewashing | LowRinseTemp-PM | 5 |
| Connected Controller | Contamination | Warewashing | LowWashTemp-AM | 4 |
| Service Tech Audit | Contamination | Food Contact | Food Contact Surfaces cleaned and | 5 |
| | | | sanitized | |
| Service Tech Audit | Contamination | Cleaning | All non-food contact surfaces are clean, | 3 |
| | | | cleanable, and in good repair | |
| Service Tech Audit | Poor Hygiene | Handwashing | Proper handwashing procedure | 5 |
| Service Tech Audit | Contamination | Food Storage | Cross contamination prevented during | 4 |
| | | | food storage and preparation | |
| Service Observations | Contamination | Warewashing | Final Rinse Temperature-Too Low | 4 |
| Service Observations | Contamination | Warewashing | Dishware-Dirty | 4 |
| HDI | Contamination | Contact | Food-contact surfaces: cleaned and | 5 |
| | | Surface | sanitized-Food Contact Surface Clean to | |
| | | | Sight and Touch | |
| HDI | Poor Hygiene | Personal | Proper eating, tasting, drinking, or tobacco | 5 |
| | | Cleanliness | use-Eating, Drinking, or Using Tobacco | |
| HDI | Cold Holding | Food Storage | Proper cooling time and temperatures- | 5 |
| | | | Cooling | |
| HDI | Contamination | Procedures | Washing fruits and vegetables-Raw fruits | 3 |
| | | | and vegetables thoroughly washed before | |
| | | | use | |
| Pest Service | Contamination | Sanitation | SANITATION ISSUES-Interior | 5 |
| Observation | | | | |
| Pest Service | Contamination | Pest Activity | PEST ACTIVITY-Interior | 5 |
| Observation | | | | |
| Products | Facility | Cleaning | GLASS (NO PURCHASE) | 1 |
| Products | Contamination | Contact | 3RD SINK/SURFACE SANITIZER (NO | 4 |
| | | Surface | PURCHASE) | |
| Products | Contamination | Handwashing | HAND SANITIZER (NO PURCHASE) | 4 |
| Products | Contamination | Contact | RINSE ADDITIVE (NO PURCHASE) | 2 |
| | | Surface | | |

Product-factor mappings 57 include a mapping from one or more of the actionable factors to one or more products or product types that may be used to address an actionable factor for the food establishment. Example actionable factor-product mappings are shown in Table 2.

TABLE 2

| Actionable Factor | Product Recommendation |
|---|---|
| DetergentOOP-AM | Detergent |
| DetergentOOP-MidDay | Detergent |
| DetergentOOP-OverNight | Detergent |
| DetergentOOP-PM | Detergent |
| RinseAidOOP-AM | Rinse Additive |
| RinseAidOOP-MidDay | Rinse Additive |
| RinseAidOOP-OverNight | Rinse Additive |
| RinseAidOOP-PM | Rinse Additive |
| All non-food contact surfaces are clean, | Kitchen Degreaser |
| cleanable, and in good repair | |
| Floors, walls, ceiling are cleanable, clean and in | Kitchen Degreasers |
| good repair | |
| Proper concentration of chemical sanitizing for | Rinse Additive, Delimer or Detergent |
| dishwashing machine | |
| Equipment maintained free of encrusted | Kitchen Degreasers |
| grease/soil deposits | |
| Cleaning agent and sanitizers are present and | Surface Sanitizers, Kitchen Degreaser, |
| readily available for use | Fryer and Grill Cleaner |
| Hand Hygiene Product DispenserOOP | Hand Hygiene Product |

Action-factor mappings 57 include a mapping from one or more of the actionable factors to one or more suggested actions that may be taken to address a failure of the food establishment to “pass” the actionable factor. Example actionable factor-suggested action mappings are shown in Table 3.

TABLE 3

| Actionable Factor | Suggested Action |
|---|---|
| DetergentOOP-AM | Refill detergent dispenser |
| RinseAidOOP-AM | Refill rinse additive dispenser |
| Improper cold holding temperatures | Food temp should be <41 F. before placed into cold |
| | hold unit |
| Rinse Temp - too low | Verify booster heater is turned on and functioning |
| | properly |
| Pest Service Observations: Sanitation issues | Work with your Pest Service Associate on a |
| observed in the interiors of the location | corrective action plan |
| Food contact surfaces of dishware not clean | Ensure proper prescrap and racking procedures |
| when inspected with sight and touch | |
| Equipment maintained free of encrusted | Use chemicals correctly and set up cleaning |
| grease/soil deposits | schedule |
| Cleaning agent and sanitizers are present and | Refill cleaning agent and/or sanitizer dispensers; |
| readily available for use | ensure readily available |
| Improper eating, drinking, or tobacco | Train employees regarding proper food safety |
| | procedures |
| Hand Hygiene Product DispenserOOP | Refill Hand Hygiene Product dispenser |

Although certain types of data are shown and described, it shall be understood that data from any other data source relevant to monitoring and evaluation of food safety performance may be stored in data storage device(s) 40, and that the disclosure is not limited in this respect.

Server computer 30 further includes one or more analysis module(s) 32 that, when executed by processor(s) 36, cause server computing device(s) 30 to analyze data (such as one or more of the data types stored in data storage device(s) 40) from one or more data sources to monitor and/or evaluate food safety performance for the one or more food establishments 14A-14N. A reporting application 34, when executed by processor(s) 36, cause server computing device(s) 30 to generate a variety of reports that present the analyzed data for use by the person(s) responsible for overseeing food safety at each food establishment 14A-14N. Reporting application 34 may generate a variety of reports 50 to provide users at the corporate entities 12A-12N or users at individual food establishments 14A-14N with various insights relating to food safety at their associated food establishments. The reports may include, for example, one or more scores indicative of food safety performance at one or more sites. The scores may be generated by individual food establishment (otherwise referred to as a “site”) or across groups of multiple food establishments (multiple “sites”). The scores may also be generated at one or more levels, including an actionable factor level, a site level, a category level, or a data source level.

The reports may further include a predictive indicator indicative of the risk that a food establishment will fail a predetermined number of standardized health department inspection questions on its next routine health department inspection. The reports may further include one or more recommended actions that may be taken to address identified actionable risk areas. The reports may further include one or more product recommendations tailored to address an identified actionable risk area. The reports may also compare food safety data (such as scores and/or predictive risk indicators) over time to identify trends or to determine whether improvement has occurred. Reporting application 34 may also allow users to benchmark food safety performance at multiple food establishments.

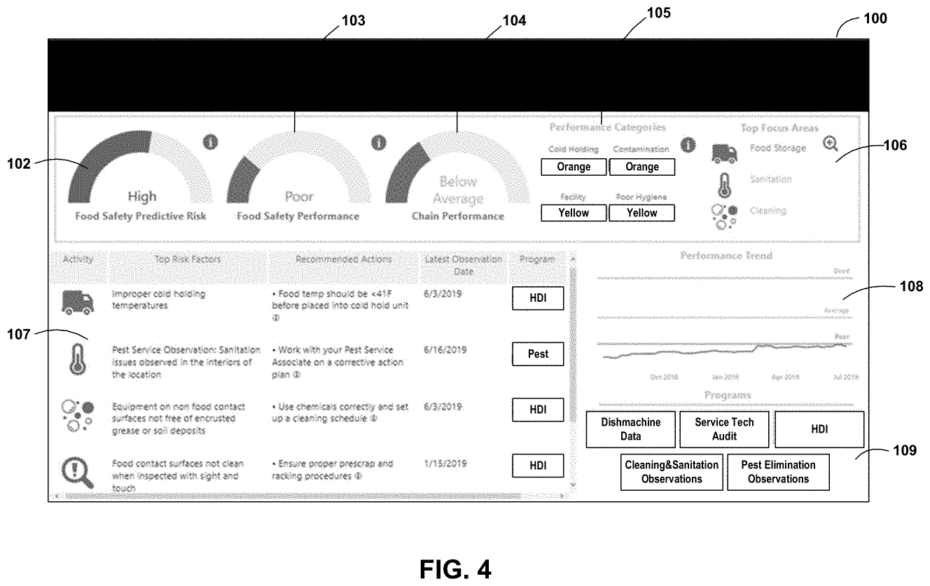

Reporting module(s) 34 may also generate, for display on a user computing device or on a computing device associated with a food establishment or corporate entity, one or more graphical user interfaces, such any one of those shown in FIGS. 4-8, that present the data (such as one or more of the data types stored in data storage device(s) 40) from one or more data sources and/or the results of the analysis. The reports may also be downloaded and stored locally at the corporate entity or individual food establishment, on an authorized user's personal computing device, on another authorized computing device, printed out in hard copy, or further communicated to others as desired. Reporting module(s) 34 may also generate notifications regarding suggested actions or product recommendations as determined by the analysis module 32. The notifications may include any form of electronic communication such as emails, voicemails, text messages, instant messages, page, video chat, etc. The notifications may be sent to any type of user computing device, such as a mobile computing device (e.g., smart phone, tablet computer, pager, personal digital assistant, etc.), laptop computer, desktop computer, etc. The user may include any one or more of a service technician or an employee of the food establishment, or an employee of a corporate entity associated with one or more food establishments.

In some examples, computing device(s) at one or more of the corporate entities 12A-12N or individual food establishments 14A-14N may include the capability to provide the analysis and reporting functions described above with respect to server computing device(s) 30. In these examples, computing device(s) associated with the corporate entity or individual food establishment may also store the above-described food safety data associated with the corporate entity or individual food establishment. The computing device(s) may also include local analysis and reporting applications such as those described above with respect to analysis and reporting applications 32 and 34. In that case, reports associated with that particular corporate entity and/or individual food establishment may be generated and viewed locally, if desired. In another example, all analysis and reporting functions are carried out remotely at server computing device(s) 30, and reports may be viewed, downloaded, or otherwise obtained remotely. In other examples, certain of the corporate entities/individual food establishments may include local storage and/or analysis and reporting functions while other corporate entities/individual food establishments rely on remote storage and/or analysis and reporting. Thus, it shall be understood that the storage, analysis, and reporting functions may be carried out either remotely at a central location, locally, or at some other location, and that the disclosure is not limited in this respect.

FIG. 1B is a block diagram of an example analysis module 32 by which a computing device may monitor and evaluate food safety performance for one or more food establishments. Analysis module 32 may include one or more software modules that, when executed by processor(s) 36, cause server computing device(s) 30 to analyze data (such as one or more of the data types stored in data storage device(s) 40) from one or more data sources to monitor and/or evaluate food safety performance for the one or more food establishments 14A-14N. For example, analysis module 32 may include a performance score module 31, a predictive risk module 33, a product recommendation module 35, a web hosting module 37 and a raw text mapping module 39. Each of these modules will be described herein in more detail below.

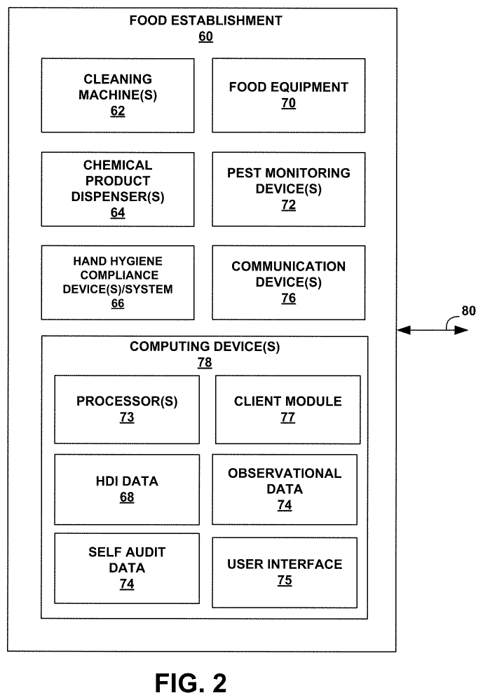

FIG. 2 is a block diagram illustrating an example food establishment 60 at which food safety performance may be monitored and evaluated. Food establishment 60 includes one or more example data sources which monitor, generate and/or or receive and store data relevant to the monitoring and evaluation of food safety performance at food establishment 60. For example, food establishment 60 includes one or more cleaning machines 62 (such as one or more dish machines, floor cleaning machines, etc.), chemical product dispensers 64, hand hygiene compliance device(s) and/or system 66, including, for example, hand hygiene product dispensers and other hand hygiene compliance devices (such as compliance badges, area monitors, sink monitors, real-time locating systems, etc.) 66, food equipment 70 (such as refrigerators, freezers, ovens, warming equipment, and other food handling and/or storage equipment), and one or more pest monitoring devices 72. Food establishment 60 also includes one or more computing device(s) 78. Computing device(s) 78 include one or more processor(s) 73 and a user interface 75. User interface 75 may include one or more input and/or output devices that permit a user to interact with computing device(s) 78. As such, user interface 75 may include any one or more of a keyboard, a mouse or other pointing device, a display device, a touch screen, a microphone, speakers, etc.

Computing devices 78 also include one or more data storage devices that store health department inspection data 68, observational data 74 and self-audit data 78 associated with the food establishment. Observational data 74 may include data observed during audits conducted by technical service personnel, such as cleaning and sanitation service audits, pest service audits, food safety service audits, etc. Self-audit data 78 may include observational data from audits conducted by employees of the food establishment, such as food safety procedural audits, and any other audits that observe whether proper procedures that may have a bearing on food safety have been followed. Any of the food safety data from any of example data sources may be transmitted from food establishment 60 by one or more communication device(s) 76 to one or more computing device(s) associated with a corporate entity or to server computing device(s) 30 as indicated by reference numeral 80.

Computing devices 78 may also include one or more data storage devices that store a client module 77. Client module 77 includes computer readable program instructions that, when executed by one or more processor(s) 73, cause computing device 78 to execute the client-side application of a web-based food safety monitoring and evaluation service, in accordance with the techniques of the present disclosure. For example, client module 77 may cause a graphical user interface displaying food safety performance data pertaining to the food establishment, such as any of those shown in FIGS. 4-8, to be displayed on user interface 75.

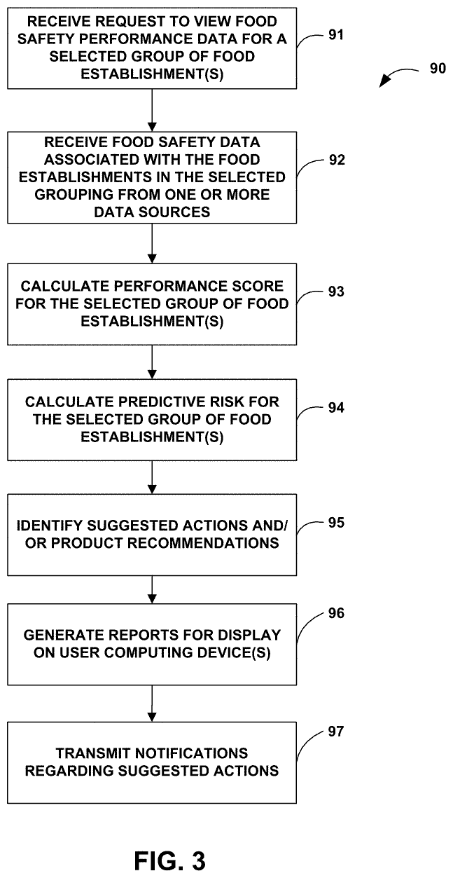

FIG. 3 is a flowchart illustrating an example process (90) by which a computing device may generate, based on analysis of food safety data from one or more data sources, a food safety performance score and a predictive risk for a selected grouping of one or more food establishments. The computing device may include, for example, a server computing device(s) 30 as shown in FIG. 1. The process (90) may be stored as computer-readable instructions in, for example, analysis module 32, and that, when executed by one or more processor(s) (such as processors 36), cause server computing device 30 to monitor and analyze food safety performance data for a food establishment or grouping of food establishments from one or more data sources in accordance with the present disclosure.

The computing device may receive a request to view food safety performance data for a selected grouping of food establishment(s) (91). For example, a user may, through interaction with a graphical user interface such as any of those shown and described with respect to FIGS. 4-8, request to view food safety performance data for a single food establishment or group of one or more food establishments as described herein. Upon receipt of this request, the computing device receives food safety data associated with the food establishments in the selected grouping from one or more data sources (92). This includes receiving any food safety data relevant for determining a food safety performance score, a predictive risk, and or suggested actions and/or product recommendations for the selected grouping of food establishment(s). As such, this may include receiving food safety data associated with food establishments that are not necessarily part of the selected grouping of food establishment(s), as such data may be relevant to the determination of the food safety performance score, a predictive risk, and or suggested actions and/or product recommendations for the selected grouping of food establishment(s).

The received food safety data (92) may be received from one or more data sources for each of the food establishments in the selected grouping of food establishments. The data sources for each food establishment in the selected grouping of food establishments need not be the same data sources as any of the other food establishments in the selected grouping. The one or more data sources may include, for example, health department inspection data, observational data, cleaning machine data, chemical product dispenser data, food service machine data, hand hygiene compliance data, and any other data that may be captured or related to food safety performance at a food service establishment. The health department inspection data, observational data, cleaning machine data, chemical product dispenser data, food service machine data, hand hygiene data, and other data may include data associated with or about the food establishment itself and may also include data associated with or about one or more other food establishments.

The computing device may generate, based on analysis of the data from the one or more data sources, performance score indicative of the food safety performance of the selected group of food establishment(s) (93). For example, performance score module 31 of FIG. 1B may store computer-readable instructions that, when executed by one or more processor(s) (such as processors 36), cause server computing device 30 to determine a performance score for a food establishment or grouping of food establishments in accordance with the present disclosure. The score may be generated by individual food establishment (otherwise referred to as a “site”) or for a selected group of multiple food establishments (multiple “sites”). The scores may also be generated at one or more levels, including an actionable factor level, a site level, a category level, or a data source level.

The computing device may also generate, based on analysis of the data from the one or more data sources, a predictive risk indicator indicative of the risk that a food establishment will fail a predetermined number of health department inspection questions on its next routine health department inspection (94). For example, predictive risk module 33 of FIG. 1B may store computer-readable instructions that, when executed by one or more processor(s) (such as processors 36), cause server computing device 30 to determine a predictive risk for a food establishment or grouping of food establishments in accordance with the present disclosure.

The computing device may further identify, based on analysis of the data from the one or more data sources, one or more suggested actions that may be taken to address identified risk areas (95). The suggested actions may include one or more product recommendations that may be used to address an identified risk area. For example, product recommendation module 35 of FIG. 1B may store computer-readable instructions that, when executed by one or more processor(s) (such as processors 36), cause server computing device 30 to determine suggested actions and/or product recommendations for a food establishment or grouping of food establishments in accordance with the present disclosure.

The computing device may further generate, for display on a user computing device, one or more reports including one or more of the food safety performance score, the predictive risk, the suggested actions and/or the product recommendations (96). For example, the computing device may generate, for display on one of user computing device(s) 22, on a computing device associated with corporate entities 12, and/or on a computing device associated with a food establishment 14, a graphical user interface such as any of those shown and described herein with respect to FIGS. 4-8. In some examples, the computing device may execute a web hosting module, such as web hosting module 37, which provides a cloud-based service that monitors and evaluates food safety performance for one or more food establishments, and through which one or more users, such as employees or managers of a food establishment or corporate entity, may receive and view one or more graphical user interfaces displaying the relevant food safety data and/or results of the food safety performance analysis.

FIG. 4 is a screen shot of an example graphical user interface 100 presenting the results of an analysis of food safety data from one or more data sources to monitor and/or evaluate food safety performance for an individual food establishment. User interface 100 may thought of as a “dashboard” in which different aspects of the food safety data for the food establishment are organized and displayed within different areas or sections of the user interface 100. In this example, a banner 110 at the top of user interface 100 displays the food establishment's name and address, “Café Ollie, 123 Main Street, Anytown, USA.” One or more food safety related scores or ratings for the food establishment may be indicated using one or more user interface elements, such as gauge icons 110, 103, and 104, or other icon that may be used for communicating a score or rating. In this example, gauge icons indicate the relative position of the calculated score or rating from a lowest score to a highest score and in which an average score is in the center.

The techniques of the disclosure may generate, based on analysis of data from one or more data sources, a predictive risk indicator indicative of the risk that a food establishment will fail a predetermined number of health department inspection questions on its next routine health department inspection. In FIG. 4, this value is the “Food Safety Predictive Risk” for the food establishment and is represented in user interface 100 by gauge icon 110 in combination with text describing the general rating or score. In this example, the Food Safety Predictive Risk score or rating for the food establishment has been determined to be “High”, and this score is indicated by gauge icon 110 being somewhere above the halfway mark. An “average” food safety predictive risk may be indicated with gauge icon 110 at the halfway point, a “low” food safety predictive risk may be indicated with gauge icon 110 relatively lower than the halfway point, etc.

The techniques of the disclosure may also generate, based on analysis of data from one or more data sources, one or more scores indicative of the food safety performance of the food establishment. In FIG. 4, this value is displayed as the “Food Safety Performance” for the food establishment and is represented in user interface 100 as gauge icon 103. In this example, the Food Safety Performance for the food establishment has been determined to be “Poor”, and gauge icon 103 displays a corresponding image having the gauge below the halfway mark. An “Average” food safety performance may be indicated by the gauge 103 at the halfway mark, an Above Average food safety performance score may be indicated with the gauge 103 relatively higher than the halfway point, etc.

The food safety performance score and the predictive risk score may be generated by individual food establishment as shown in FIG. 4 (otherwise referred to as a “site”) or across one or more groups of multiple food establishments (multiple “sites”). Thus, the food safety performance of an individual food establishment may be compared to the food safety performance of the other locations, or sites, associated with the same corporate entity. For example, an individual food establishment's food safety performance may be compared with the food safety performance of one or more other sites in a restaurant “chain.” In FIG. 4, this value is indicated as the “Chain Performance” and is represented in user interface 100 by gauge icon 104. In this example, the Chain Performance for the food establishment has been determined to be “Below Average”, and gauge icon 104 displays a corresponding image in which the gauge is below the halfway (or average) mark.

The scores may also be generated at one or more levels, including an actionable factor level, a site level, a category level, or a data source level. The actionable factor level is the most specific way to identify failure and correspondingly has specific recommended action(s) and/or products associated with it. Examples of this could include, observations identifying mold on specific machines, ware wash sanitization rates and identifying inside sanitization issues that could attract pests. The sub-category level is less specific and more general than the factor level. Examples of this include food storage, sanitization and cleaning. The category level is less specific and more general than the sub-category level. Examples of this include contamination and poor hygiene. The overall performance score covers all factors and is the most general view of a site's results. When used together these different levels of analysis allow for results to be generated ranging from specific issues to a general level assessment and support different roles and areas of responsibility within food service locations. The user interface for a food establishment may display performance scores on an actionable factor level, site level, etc. for the food establishment.

In the example of FIG. 4, the “Performance Categories” 105 displayed for the food establishment include cold holding, contamination, facility, and poor hygiene. The icons corresponding to each performance category may be color coded to indicate the relative level of food safety performance for that category. In the examples of FIGS. 4-8, the color levels are green=excellent, light green=good, yellow=above average, orange=below average, red=poor, and dark red=very poor. However, it shall be understood that any other means of communicating levels of performance may also be used. By indicating a relative score for each performance category, the graphical user interface enables a user to easily view and understood where the food establishment is performing well or performing poorly. This may further enable a food establishment to diagnose and address problems related to food safety, and thus to increase their performance score and/or lower their predictive risk (i.e., probability that the food establishment will fail a predetermined number of standardized health department inspection questions on their next health department inspection).

User interface 100 further includes an area 106 presenting the “Top Focus Areas” for the food establishment. The Top Focus Areas are those areas that the system determines are the most concerning areas with respect to food safety performance. In the example of FIG. 4, the top focus areas were determined to be Food Storage, Sanitation, and Cleaning. By highlighting the Top Focus Areas, the system is able to determine and present the areas where a food establishment may focus in order to increase their food safety performance score and/or lower their food safety predictive risk (probability of failing a predetermined number of standardized health department inspection questions on their next health department inspection) in a clear and actionable way.

User interface 100 further includes a table 107 presenting more detailed information concerning the areas of concern for the food establishment. In the example of FIG. 4, table 107 includes multiple columns, listed as Activity, Top Actionable Factors (listed in FIGS. 4-8 as “Risk Factors”, Recommended Actions, Latest Observation Date, and Program. The Activity column lists one or more areas of concern for the food establishment; in this example, the Activity column shows an icon corresponding to each activity, in which an image of a truck corresponds to food storage activities, an image of thermometer corresponds to sanitation activities, an image of soap bubbles corresponds to cleaning activities, and an image of a magnifying glass corresponds to food contact surface inspection activities.

The Top Actionable Factor column displays a text description of one or more actionable factors of concern for the associated activity. In the top row, the actionable factor was determined to be “Improper cold holding temperatures.”

The techniques of the disclosure may further generate, based on analysis of the data from the one or more data sources, one or more recommended actions that may be taken to address identified actionable risk areas. The recommended actions may include one or more product recommendations tailored to address an identified actionable risk area. The Recommended Actions column of table 107 displays a text description of actions that may be taken to address the concern. For the food storage concern, the Recommended Action was determined to be “Food temp should be <41 F before placed into cold hold unit.” An information icon, denoted by an “I” inside of a circle, may be clicked on or hovered over to bring up further details concerning the Recommended Actions. The Latest Observation Date for each row is also listed, and the data source from which the actionable factors were determined is shown under the “Program” column of chart 107. In the example of FIG. 4, the data source for the “Food Storage” actionable concern “improper cold holding temperatures” was health department inspection data (HDI) for the food establishment.

User interface 100 also includes a graph 108 showing the food safety performance of the food establishment over time. In the example of FIG. 4, the food safety performance is graphed from October of 2018 to July of 2019 and the food safety performance is shown to be “Poor” during that time period, which corresponds to the “Poor” Food Safety Performance shown in gauge 103.

User interface 100 also includes an area 109 in which are displayed the one or more data sources from which the food safety data for the food establishment was determined. The one or more data sources may include, for example, health department inspection data, observational data, cleaning machine data, chemical product dispenser data, food service machine data, hand hygiene data, and any other data that may be captured or related to food safety performance at a food service establishment. The health department inspection data, observational data, cleaning machine data, chemical product dispenser data, food service machine data, hand hygiene data, and other data may include data associated with or about the food establishment itself and may also include data associated with or about one or more other food establishments. In the example of FIG. 4, the data sources from which the food safety data for the food establishment was determined include dish machine data, service tech audit data, HDI data, cleaning and sanitation services observational data, and pest elimination services observational data.

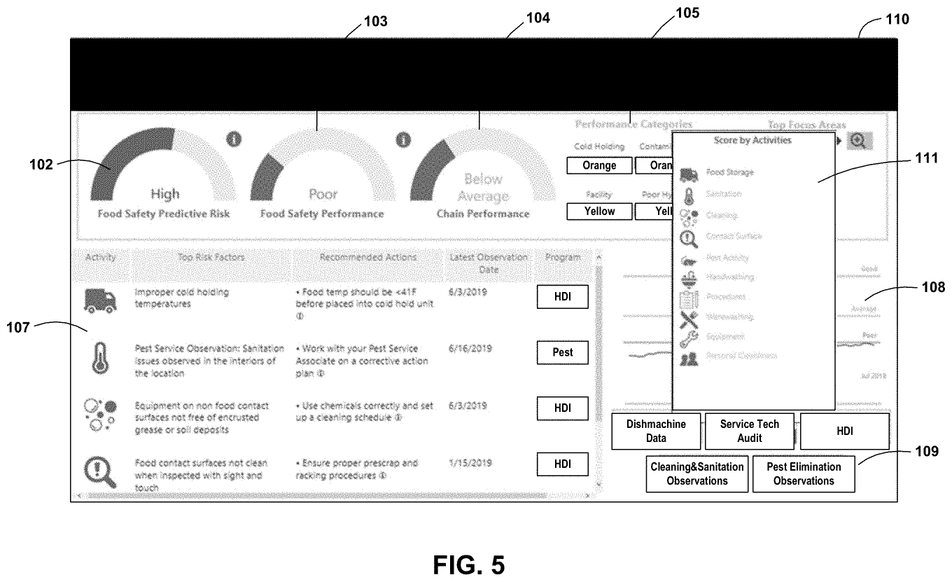

FIG. 5 is a screen shot of another example user interface 110 presenting the results of an analysis of food safety data from one or more data sources to monitor and/or evaluate food safety performance for the same food establishment as shown in FIG. 4. To arrive at user interface 110 of FIG. 5, a user may actuate an icon, such as the magnify icon the Top Focus Area field 106 of FIG. 4, such as by a mouse click, hovering over, etc. In response to actuation of the magnify icon by a user, the system causes a Score by Activities pop-up window 111 to open. The Score by Activities pop-up window 111 presents a list of each “Activity” for the food establishment. In this example, the Activities for the food establishment include food storage, sanitation, cleaning, contact surfaces, pest activity, handwashing, procedures, warewashing, equipment, and personnel cleanliness. The sub-categories shown are color coded based on the associated food safety score for that sub-category. The list may be user-selectable by which, when selected by a user, may cause food safety performance scores for each individual sub-category to be displayed.

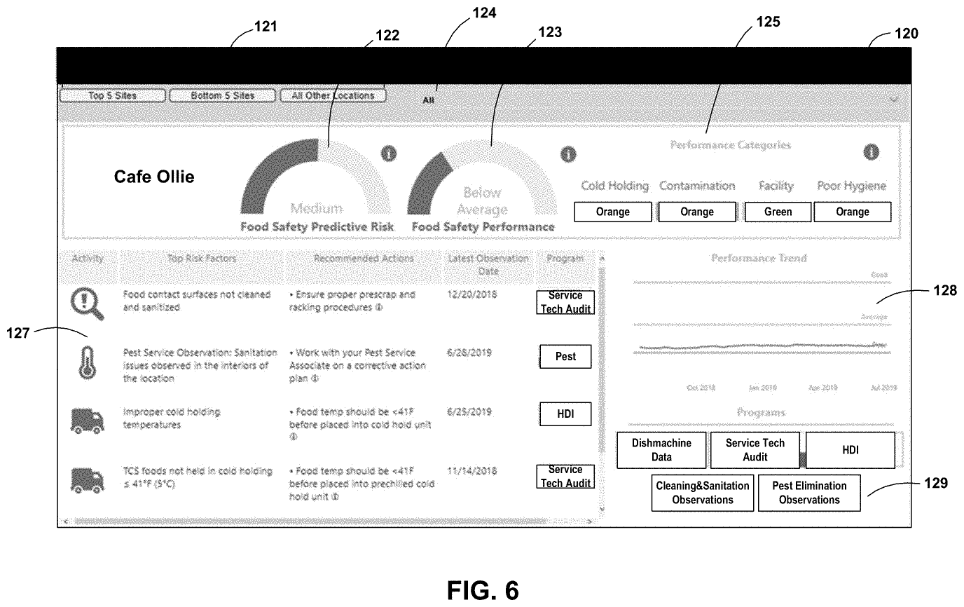

FIG. 6 is a screen shot of another example graphical user interface 120 presenting the results of an analysis of food safety data from one or more data sources to monitor and/or evaluate food safety performance for an “all sites” group of food establishments associated with a single corporate entity. User interface 120 may thought of as a “dashboard” in which different aspects of the food safety data for all sites of a corporate food entity may be organized and displayed within different areas or sections of user interface 120. In this example, one or more user interface elements, such as site grouping buttons 121 and pull-down menu 124 at the top of user interface 120, selectable by a user to choose among various groupings for the corporate food entity. In the example of FIG. 6, the groupings include Top 5 Sites (the 5 best performing sites in terms of food safety performance score), Bottom 5 Sites (the 5 worst performing sites in terms of food safety performance score), All Other Locations (all locations except the top 5 and bottom 5 sites), and All sites (all of the sites associated with a corporate food entity). In this example, if “All” is selected from pull-down menu 124 and none of the Top 5, Bottom 5, or All Other Location soft buttons are actuated (as is the case in FIG. 6), the food safety performance score for All sites is displayed.

Similarly to user interface 100 of FIG. 4, which displays food safety performance data and results for a single food establishment or site, one or more food safety related scores for the corporate food entity may be indicated using one or more user interface elements, such as gauge icons 122 and 123, or other icon for communicating a relative score. In this example, user interface 120 includes a gauge icon 122 indicative of the Food Safety Predictive Risk for the selected group for the corporate food entity and a gauge icon 123 indicative of the Food Safety Performance for the selected group for the corporate food entity. In the examples presented herein, the predictive risk for the group of sites is the average of predictive risk of all sites in the group. An example calculation of a performance score for a group of sites is described herein below.

User interface 120 further presents one or more scores corresponding to various Performance Categories 125 for the selected group of sites. The score or rating for each category (e.g., excellent, good, above average, average, below average, poor, very poor, etc.) may be indicated by color coded icons. User interface 120 further includes a table 127 displays the top activities of concern for the corporate food entity or selected group of sites, the top actionable factor for each displayed activity, one or more recommended actions, a latest observation date, and the data source from which the activity was identified. User interface 120 further includes a graph 128 displaying the food safety performance score over time for the corporate entity or group of sites, and icons 129 indicative of the data sources from which the food safety data and performance scores were determined. In the example of FIG. 6, the data sources 129 for all sites of the corporate entity “Café Ollie” included dishmachine data, service tech audit data, health department inspection data (HDI), cleaning and sanitation observational data, and pest elimination service observational data.

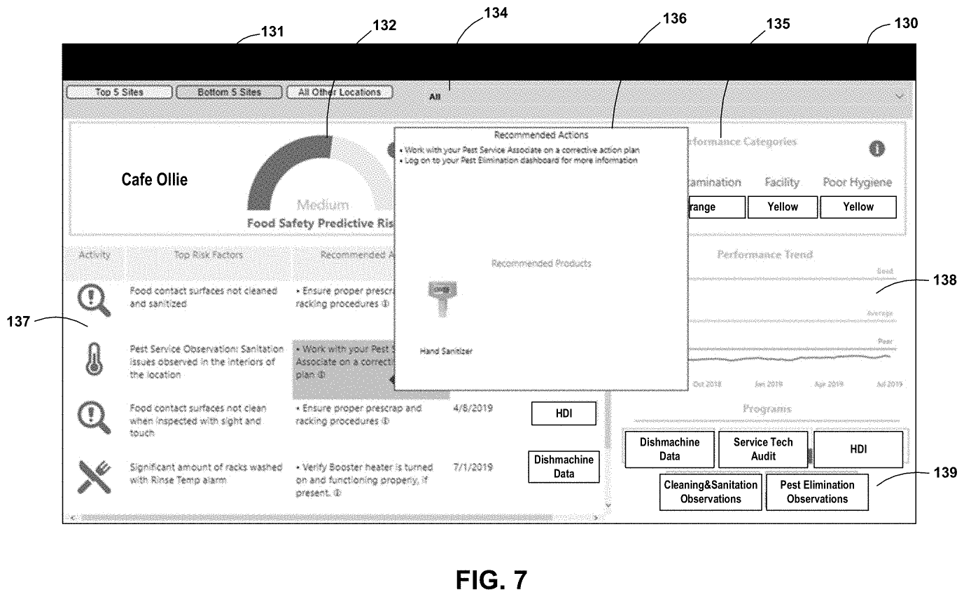

FIG. 7 is a screen shot of another example graphical user interface 130 presenting the results of an analysis of food safety data from one or more data sources to monitor and/or evaluate food safety performance for a “Bottom 5” group of food establishments associated with the single corporate entity of FIG. 6. To arrive at user interface 130, a user has actuated the “Bottom 5” button 131. In this example, actuation of the “Bottom 5” button is indicated by graying out or otherwise changing the color of the button as compared to the un-actuated buttons. All of the scores and food safety performance data shown in user interface 130 correspond to the “Bottom 5” or 5 lowest performing sites for the corporate food entity. A comparison of user interface 130 with user interface 120 of FIG. 6 shows that table 137 for the bottom 5 sites is different than the table 127 for all sites, and that graph 138 displays a relatively lower overall performance score over time for the bottom 5 sites as compared to graph 128 for all sites. Actuation of the “Top 5 Sites” or “All Other Locations” buttons would similarly result in display of data and results corresponding to those selected groupings.

User interface 130 also includes a “Recommended Actions” pop-up window 136. Such a window may be arrived at from any of user interfaces 130, 120, 110 or 100 by actuating one of the information icons in the Recommended Actions column of tables 137, 127, 117 or 107, respectively. In this example, the “Recommended Action” pop-up window 136 displays one or more recommended actions that may be taken to address the specific actionable concern. Pop-up window 136 also displays a product recommendation, in this example, a particular brand or type of hand sanitizer, that may be used to address the specific actionable concern.

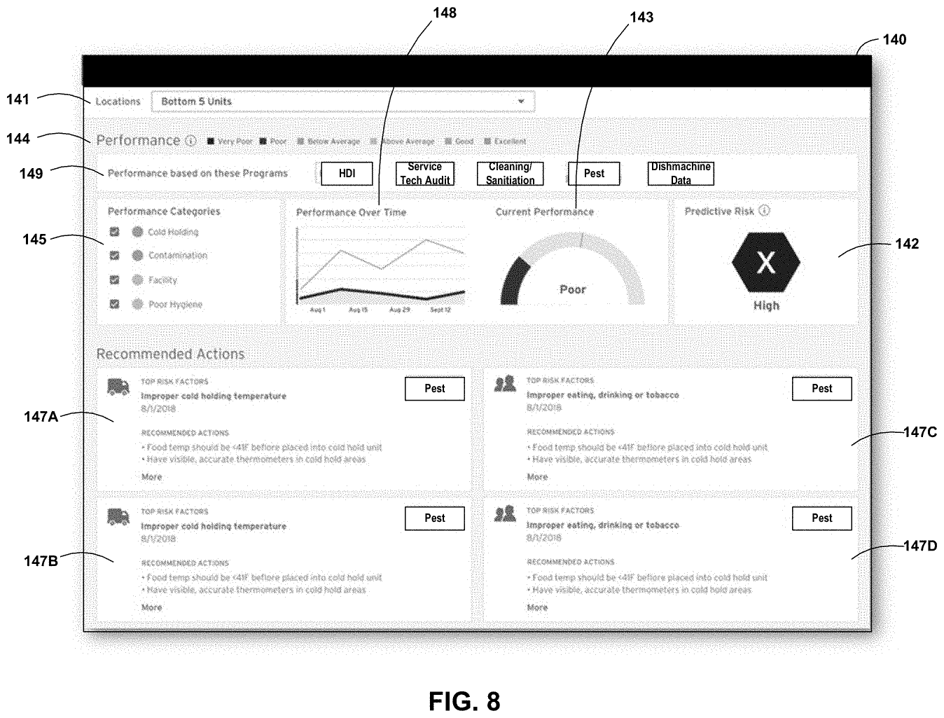

FIG. 8 is a screen shot of another example graphical user interface 140 presenting the results of an analysis of food safety data from one or more data sources to monitor and/or evaluate food safety performance for a “bottom 5” sub-group of food establishments associated with a single corporate entity. User interface 140 includes a pull-down menu 141 by which a user may choose between one or more groups of sites to be displayed. In this example, a user has elected to view food safety performance data for the Bottom 5 units of the ABC Restaurant chain.

A Performance key 144 includes a list of the possible ratings and corresponding color-coding for each (e.g., very poor (dark red), poor (red), below average (orange), above average (yellow), good, (light green), and excellent (green)). An area 149 displays one or more icons indicative of the data source(s) from which the food safety performance data was obtained. A color-coded icon for each of one or more Performance Categories is shown in area 145. In this example, there are a total number of 4 categories, so icons corresponding to each of the 4 performance categories are shown.

A Performance Over Time graph 148 displays the food safety performance score for the selected grouping of sites over time, and the current food safety performance scores is indicated by gauge icon 143. The food safety predictive risk (the probability that any sites within the grouping may fail a predetermined number of standardized health department inspection questions on their next health department inspection) is indicated in this example by an “x” within a red hexagon icon 142. An acceptable food safety predictive risk may be indicated by a check mark inside a green hexagon, for example.

One or more content panes 147A-147D, or generally content panes 147, include detailed Recommended Actions information for several actionable factors for the “Bottom 5” grouping of FIG. 8. For example, content pane 147A includes Recommended Actions for the top actionable factor, “Improper cold holding temperature” that was identified by observation during a Pest Service call or audit on Aug. 1, 2018. Content pane 147C includes Recommended Actions for the top actionable factor, “Improper eating, drinking, or tobacco” that was also identified by observation during the Pest Service call or audit on Aug. 1, 2018. The one or more Recommended Actions content panes 147 may include one or more actions to mitigate specifically identified areas of risk (from procedure adherence, equipment maintenance, product usage, facility maintenance, etc.). The Recommended Actions may also include one or more product recommendations for specific products that may be used to address the identified risk area.

The following describes an example algorithm for generating a food safety performance score (or simply, “performance score”) based on data from one or more data sources in accordance with the present disclosure. With this example scoring algorithm, performance scores generated using different data sets are comparable. In other words, the same meaning can be attributed to the calculated performance scores even though the types of data upon which the scores are based may be different. For example, a first performance score for a first food establishment generated using HDI data and product usage data is comparable to a second performance score for a second food establishment generated using HDI data, product usage data, observational data, dishmachine data. Similarly, performance scores generated for groups of one or more sites are comparable to each other and to performance scores generated for individual sites.

The performance score calculation algorithm may be stored as computer-readable instructions in, for example, performance score module(s) 31 as shown in FIG. 1B, and that, when executed by one or more processor(s) (such as processors 36), cause server computing device 30 to determine a performance score for one or more food establishments in accordance with the techniques of the present disclosure.

The example performance scores are designed to cover a range from 0-100, with 0 being the lowest performance score and 100 being the highest performance score. The example performance scores are also designed such that 50 is a “balanced” performance score. In other words, the performance scores are designed such that 50 represents average performance for all food establishments of the same type. For example, the types of food establishments may include full-service restaurants, quick serve restaurants, fast food restaurants, cafeterias, lodging, long-term care facilities, etc.

Actionable Factor Identification/Grouping Variables

i=identifies a specific actionable factor (aka site_key)
m=the set of all possible factors for a site/brand
k=the set of completed and usable factors from wireframe
j=the set of all factors associated with a program (i.e., HDI or connected apex)
h=the set of all factors associated with Health Department Inspections, not dependent on the site on which the calculations is being applied

Variables

Actionable factors are defined as the transformed data inputs data that are used for score calculation. They represent detailed inputs that identify specific areas of failure that can be acted on. Typical actionable factors include those things that can be passed, failed or have an associated pass percentage. Additionally, an overall pass rate and fail rate can be calculated for a specific market segment (e.g., a type of food establishment). This can be used to set expectations for actionable performance. Subject matter expertise can be used to increase or decrease the influence (i.e., one or more weights) a specific actionable factor has in score calculation (see, for example, the examples shown in Table 1). For example, actionable factors that are more closely tied to foodborne illnesses may have greater influence. Additionally, depending on the source of the data, the actionable factor may have a greater or a lesser influence. These properties can be quantified in the following variables:

N=total number of sites calculation is being applied to
Fᵢ=average failure rate of i over whole FSR data set.
Pᵢ=average pass rate of i over whole FSR data set.
Tᵢ=Time threshold associated with specific actionable factor
wᵢ=Weight assigned to specific actionable factor
dᵢ=Data source weight adjustment associated with i
s=½ (score scaling parameter)

Windowing Functions

$$COS ( t , T ) = \begin{matrix}If t \leq T and t \geq 0 & cos ( \frac{t \times Π}{2 \times T} ) \\ else & 0\end{matrix}$$

$$BIN ( t , T ) = \begin{matrix}If t \leq T and t \geq 0 & 1 \\ else & 0\end{matrix}$$

The purpose of the windowing functions is to ensure that only relatively more recent (and therefore presumably more relevant) actionable factors are considered when calculating the performance score. For example, with the BIN windowing function, the influence of an actionable factor on the calculation of the performance score is 1 before a specified time, T, and 0 after the specified time, T. In this way, any data obtained within the time, T, will be considered when calculating the performance score, while any data older than time, T, will not be considered. With the COS windowing function, the influence of an actionable factor is decreased over time in accordance with a cosine function, until after a time, T, it will no longer have any influence on the performance score. In this way, the most recent data has a stronger influence on the resulting performance score than does less recent data, and any data older than time, T, will have no influence on the performance score.

Site Level Calculations:

At the site level, a weighted average is calculated for each of its actionable factors to determine the average performance for the actionable factor at a specific point in time. The COS and BIN windowing functions can be used for this. Specific data sources may have an additional weighting component if needed. This results in average actionable factor values calculated at the site level.

\ddot{f}_{i,*}=Fail rate associated with each actionable factor occurrence
\ddot{p}_{i,*}=Pass rate associated with each actionable factor occurrence
\ddot{t}_{i,*0}=Time associated with each actionable factor instance occurrence
\ddot{t}_{i,*}=Time of Score Calculation−\ddot{t}_{i,*,0}
ü_{i,*}=COS(\ddot{t}_{i,*}, Tᵢ) or BIN(\ddot{t}_{i,*}, Tᵢ)

\ddot{v}_{i,*}=Value weighting. Typically 1 for most data sources

\dot{f}ᵢ=Weighted Average(\ddot{f}_{i,*},ü_{i,*}×\ddot{v}_{i,*}), over all actionable factor occurrences with ü_{i,*}≠0
\dot{p}ᵢ=Weighted Average(\ddot{p}_{i,*},ü_{i,*}×\ddot{v}_{i,*}) over all actionable factor occurrences with ü_{i,*}≠0
\dot{t}ᵢ=min(\ddot{t}_{i,*}), over all actionable factor occurrences with ü_{i,*}≠0
\dot{u}ᵢ=COS(\dot{t}ᵢ, Tᵢ) or BIN(\dot{t}ᵢ, Tᵢ)

Multi-Site Level Calculations

For all the sites that score values must be calculated for, actionable factor level pass rate and failure rate values can be found by performing a weighted average calculation on each site's corresponding pass rate and fail rate values. This uses each site's time values as weights. If only a single site is of interest, this weighted average will not change the pass rate and failure rates.

fᵢ=Weighted Average(\dot{f}ᵢ, \dot{u}ᵢ), over all sites with \dot{u}ᵢ≠0
pᵢ=Weighted Average(\dot{p}ᵢ, \dot{u}ᵢ), over all sites with \dot{u}ᵢ≠0
cᵢ=(Σ\dot{u}ᵢ)/N, over all sites (with and without \dot{u}ᵢ≠0)

The amount of positive evidence for the score calculation is a function of the calculated pass rate, the expected pass rate, subject matter expertise weighting, time weighting of the actionable factor, and the weighting of the data source. Likewise, the negative evidence for the score calculation is a function of the fail rate, expected fail rate, subject matter expertise weighting, time weighting, and data source weighting.

$$Fail Sum = {Σ}_{i ∈ m} ( \begin{matrix}if {F}_{i} < 0.5 & {f}_{i} {w}_{i} {c}_{i} {d}_{i} \\ else & \frac{{P}_{i}}{{F}_{i}} {f}_{i} {w}_{i} {c}_{i} {d}_{i}\end{matrix} )$$

$$Pass Sum = {Σ}_{i ∈ m} ( \begin{matrix}if {P}_{i} < 0.5 & {p}_{i} {w}_{i} {c}_{i} {d}_{i} \\ else & \frac{{F}_{i}}{{P}_{i}} {p}_{i} {w}_{i} {c}_{i} {d}_{i}\end{matrix} )$$

$${Coverage}_{HDI} = \frac{{Σ}_{i ∈ h} ( \begin{matrix}if {F}_{i} < 0.5 & {F}_{i} {w}_{i} {d}_{i} \\ else & {P}_{i} {w}_{i} {d}_{i}\end{matrix} )}{{Σ}_{i ∈ m} ( \begin{matrix}if {F}_{i} < 0.5 & {F}_{i} {w}_{i} {c}_{i} {d}_{i} \\ else & {P}_{i} {w}_{i} {c}_{i} {d}_{i}\end{matrix} )}$$

The variable CoverageHDI is

$${Delta}^{′} = \frac{( Pass Sum - Fail Sum )}{5}$$

$$Delta = \begin{matrix}if {Coverage}_{HDI} < 1 & {Coverage}_{HDI} \times {Delta}^{′} \\ else & {Delta}^{′}\end{matrix}$$

$$Score = \begin{matrix}if Delta > 0 & 50 [ 1 + ( 1 - {s}^{Delta} ) ] \\ else & 50 [ 1 - ( 1 - {s}^{- Delta} ) ]\end{matrix}$$

The performance score calculation is designed to ensure the resulting performance score takes into account both positive and negative evidence for the food establishment (e.g., positive evidence includes data indicating that the food establishment “passed” a particular actionable factor, and negative evidence includes data indicating that the food establishment “failed” a particular actionable factor), be on a scale between 0-100, with 50 as a balanced score, and to create comparable scores, even if the sites in question have differing data sets. To achieve this comparison capability, consistent units of measuring risk are used in scoring process. Specifically, the scoring logic accounts for translating the information across different data sets into common units of measurement for food safety management (e.g., mapping food safety data associated with a food establishment from one or more data sources to a set of actionable factors); qualification and calibration of an observed issue based on typical observation failures and passes across the market (e.g., pass rate and fail rate for a group of similar food establishments); and scaling of the risk according to criticality (assigning weights to each of the actionable factors).

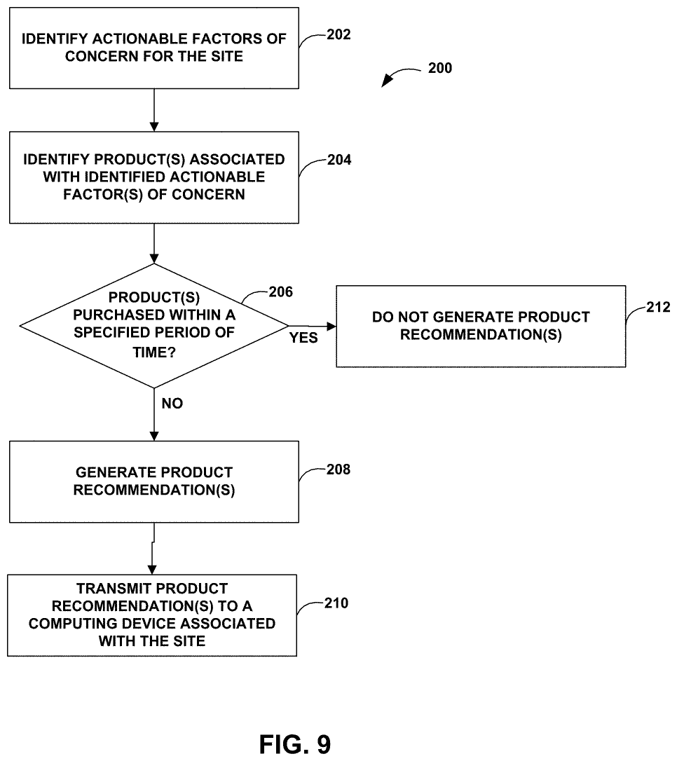

FIG. 9 is a flowchart illustrating an example process (200) by which a computing device(s) may generate a product recommendation in accordance with the techniques of the present disclosure. The computing device may include, for example, a server computing device(s) 30 such as shown in FIG. 1. The process (200) may be stored as computer-readable instructions in, for example, analysis module(s) 32 as shown in FIG. 1, and that, when executed by one or more processor(s) (such as processors 36), cause server computing device 30 to generate a product recommendation in accordance with the techniques of the present disclosure.

In general, the example process (200) is designed to ensure that product recommendations for a particular product are only generated in the event that a food establishment has not purchased the product for a specified period of time. In other words, process (200) will generate a product recommendation only if a product is determined to be “inactive” for that food establishment. This helps to eliminate product recommendations that are unlikely to lead to product purchase and also to reduce the number of non-value-added communications from a customer perspective. To that end, the computing device determines whether a particular product has been purchased by the site within a specified period of time. If the site has not purchased the product within the specified period of time, the computing device generates a product recommendation associated with the product. If the site has purchased the product within the specified period of time, the computing device will not generate a product recommendation associated with the product.

The computing device may identify one or more actionable factors of concern for the food establishment (202). For each actionable factor, the computing device may identify one or more product(s) associated with the actionable factor that may be used to address, mediate, or correct that actionable factor (204). For example, if the actionable factor is that employees at the site are not washing their hands frequently enough (an actionable factor that may be identified based on hand hygiene compliance data), an associated product may include a hand hygiene product. As another example, if the actionable factor is that a chemical product dispenser associated with a dish machine is empty (an actionable factor that may be identified based on dishmachine data, product dispenser, and/or observational data), an associated product may include a type of dish machine detergent.

For each identified product associated with the actionable factor(s) of concern, the computing device may determine whether that product has been purchased by the site within a specified period of time (206). If the product has not been purchased by the site within the specified period of time (NO branch of 206), the computing device generates a product recommendation associated with the product (208). If, on the other hand, the product has not been purchased by the site within the specified period of time (YES branch of 206), the computing device does not generate a product recommendation for that product (210). For example, if the specified period of time is 6 months, and if the product has not been purchased by the site within the last 6 months, the computing device generates a product recommendation for the identified product. If the product has been purchased by the site within the last 6 months, the computing device will not generate a product recommendation for the identified product.

The computing device may further transmit the product recommendation to a computing device associated with the food establishment (210). The product recommendations may be displayed on a graphical user interface on a user computing device or a computing device associated with the food establishment or with a corporate entity, such as any of graphical user interfaces shown and described with respect to FIGS. 4-8. The product recommendations may also take the form of notifications sent to one or more users associated with the food establishment. For example, a notification including the actionable factor and the associated product recommendation may be sent to one or more users via any form of electronic communication such as emails, voicemails, text messages, instant messages, page, video chat, etc.

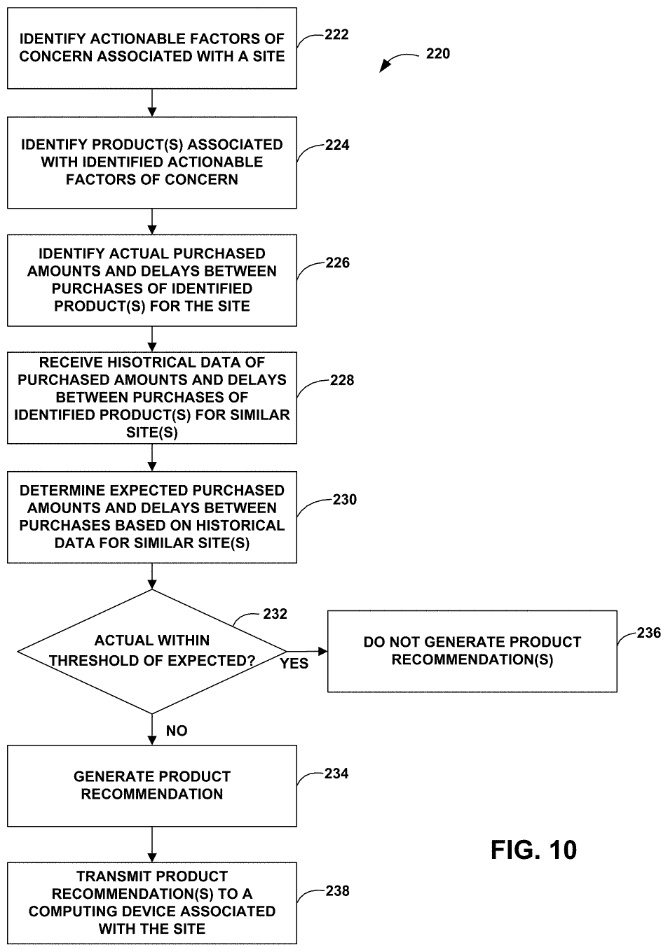

FIG. 10 is a flowchart illustrating another example process (220) by which a computing device(s) may generate a product recommendation in accordance with the techniques of the present disclosure. The computing device may include, for example, a server computing device(s) 30 such as shown in FIG. 1. The process (220) may be stored as computer-readable instructions in, for example, analysis module(s) 32 as shown in FIG. 1, and that, when executed by one or more processor(s) (such as processors 36), cause server computing device 30 to generate a product recommendation in accordance with the techniques of the present disclosure.

In general, the example process (220) is designed to ensure that product recommendations for a particular product are not generated in the event that a food establishment is already purchasing that product. To that end, historical sales data for the food establishment, and historical sales data for a group of “similar” food establishments, is analyzed to determine whether the site's purchase history for the product matches an “expected” purchase history based on the historical purchases of the product by the group of similar sites.

The computing device may identify one or more actionable factors of concern (i.e., actionable factors that the food establishment did not “pass”) for the food establishment (222). For each identified actionable factor, the computing device may identify one or more product(s) associated with the actionable factor that may be used to address, mediate, or correct that actionable factor (224). As described above, for example, if the actionable factor is that employees at the site are not washing their hands frequently enough (a factor that may be identified based on hand hygiene compliance data), an associated product may include a hand hygiene product. As another example, if the actionable factor is that a chemical product dispenser associated with a dish machine is empty (a factor that may be identified based on dishmachine data, product dispenser, and/or observational data), an associated product may include a type of dish machine detergent.

The computing device identifies, based on historical sales data for the site, actual purchased amounts and delays (i.e., amount of time) between purchases of the identified product(s) for the site (226). The computing device also receives historical sales data for a group of “similar” sites (228). For example, the group of similar sites may include sites that are the same type of food establishment. Example types or groups of food establishments may include, for example, full service restaurants, quick serve restaurants, fast food restaurants, cafeterias, lodging, long-term care facilities, and any other type or grouping of food establishments. The computing device determines, based on the historical sales data for the group of similar sites, an expected purchase amount and expected delay between purchases of the product for the group of similar sites (230).

The computing device may then compare the actual purchased amounts and the actual delay in purchases for the site to the expected purchase amounts and the expected delay in purchases for the group of similar sites, respectively (232). If the difference exceeds a threshold (NO branch of 232), the computing device generates a product recommendation corresponding to the product (234). In other words, if the actual purchased amount is different from the expected purchased amount by more than a specified threshold, and/or if the actual time delay between purchases is different from the expected time delay between purchases by more than a specified threshold time delay), the computing device generates a product recommendation corresponding to the product (234).

Conversely, if the difference exceeds a threshold (YES branch of 232), the computing device will not generate a product recommendation corresponding to the product (236). In other words, if the actual purchased amount is not different from the expected purchased amount by more than a specified threshold, and if the actual time delay between purchases is not different from the expected time delay between purchases by more than a specified threshold time delay), the computing device will not generate a product recommendation corresponding to the product (236).

For example, if the product recommendation associated with an actionable factor for a first full service restaurant is a hand hygiene product, and the expected time delay between purchases is 3 months for a group including a plurality of other full service restaurants, the computing device will generate a product recommendation for the hand hygiene product if the site has not purchased the hand hygiene product within the last 3 months or so (3 months plus the specified threshold time).

The computing device may further transmit the product recommendation to a computing device associated with the food establishment (238). The product recommendations may be displayed on a graphical user interface on a user computing device or a computing device associated with the food establishment or with a corporate entity, such as any of graphical user interfaces shown and described with respect to FIGS. 4-8. The product recommendations may also take the form of notifications sent to one or more users associated with the food establishment. For example, a notification including the actionable factor and the associated product recommendation may be sent to one or more users via any form of electronic communication such as emails, voicemails, text messages, instant messages, page, video chat, etc.

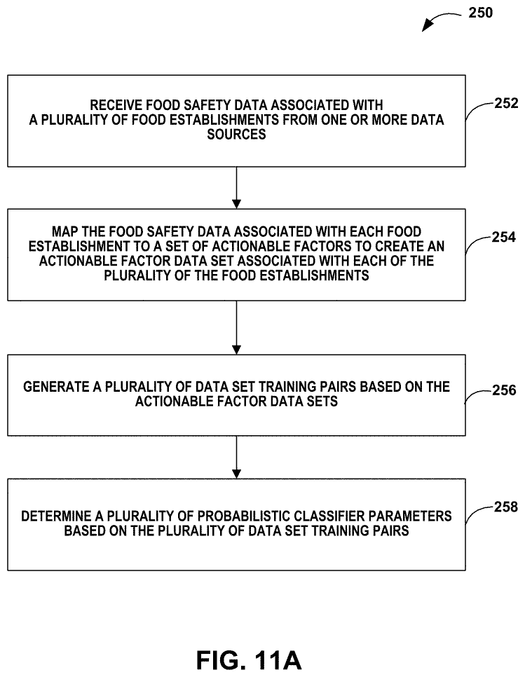

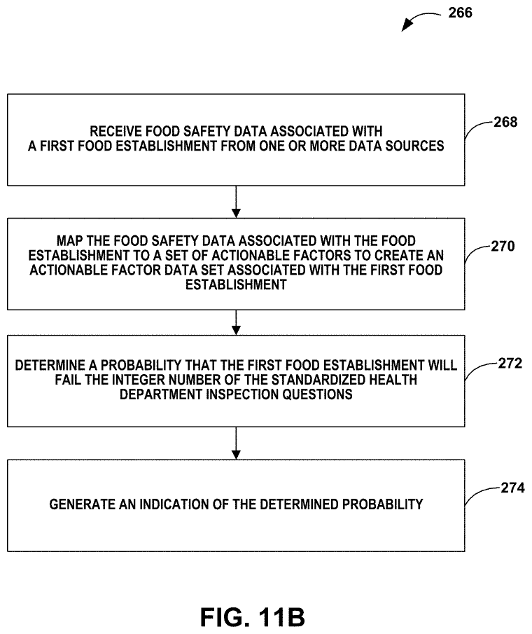

FIGS. 11A-11B are a flowchart illustrating an example process (250, 266) by which a computing device may generate a predictive risk indicator, or, in other words, a probability that a food establishment will fail an integer number of standardized health department inspection questions on its next health department inspection. The example process (250, 266) may be stored as computer-readable instructions, such as in predictive risk module 33 of FIG. 1B, that, when executed by a computing device, such as server computer device 30 of FIG. 1A, cause the computing device to determine a predictive risk for a food establishment. As such, predictive risk module 33 may include a machine learning algorithm that includes, for example, a probabilistic classifier, or other trained neural network, that predicts a probability that a food establishment will fail an integer number of the standardized health department inspection questions. To that end, the example process (250) employs machine learning to make learned predictions relating to the likelihood, or probability, that a food establishment will fail an integer number of standardized health department inspection questions on its next (e.g., upcoming) health department inspection.

In preparation for a training phase, in other words, during a pre-processing phase, the computing device receives food safety data associated with a plurality of food establishments from one or more data sources (252). The food safety data associated with the each of the plurality of food establishments may include data from one or more data sources including past health department inspection data, observational data, self-audit data, cleaning machine data, chemical product dispenser data, food service machine data, hand hygiene compliance data, and any other data that may be captured or related to food safety performance at a food service establishment. The data sources for each of the plurality of food establishments may or may not be the same. In other words, the food safety data associated with each of the plurality of food establishments does not necessarily come from the same group of one or more data sources.

Further in preparation for the training phase, the computing device maps the food safety data associated with each of the plurality of food establishments to a set of actionable factors to create an actionable factor data set associated with each of the plurality of food establishments (254). The computing device may store one or more mappings, such as data-factor mappings 56 as shown in FIG. 1A, that relate individual data points of the food safety data received from one or more data sources to a set of actionable factors. The food safety data from the one or more data sources may be mapped to the set of actionable factors to create the actionable factor data set.

The computing device generates a plurality of data set training pairs based on the actionable factor data sets associated with the plurality of food establishments (256). The plurality of data set training pairs are used to train a neural network (e.g., a probabilistic classifier) to determine a probability that a food establishment will fail an integer number of standardized health department inspection questions on its next health department inspection.

For example, a first data set of each training pair includes an actionable factor training data set associated with one of the plurality of food establishments, and a second data set of each training pair includes a standardized health department inspection questions training data set for the same one of the plurality of food establishments. The standardized health department inspection questions training data set may include standardized health department inspection questions data associated with the actionable factor training data set for the food establishment. In other words, the results of the standardized health department inspection questions are sufficiently near in time to the actionable factor training data such that those results may be reliably attributed to the conditions present when the food safety data from which the actionable factor training data sets were determined was obtained.

During a training phase, the computing device determines a plurality of probabilistic classifier parameters based on the plurality of data set training pairs (258). In this example, the probabilistic classifier predicts a probability that a food establishment will fail an integer number of the standardized health department inspection questions.

During a prediction phase (266), as shown in FIG. 11B, the computing device receives food safety data associated with a first food establishment from one or more data sources (268). The first food establishment is the food establishment for which the probability of failing an integer number of standardized health department inspection questions on its next (e.g., upcoming) health department inspection is to be determined. In some examples, the first food establishment may be one of the plurality of food establishments whose food safety data was used during determination of the plurality of probabilistic classifier parameters. In other examples, the first food establishment is not one of the plurality of food establishments whose food safety data was used during determination of the plurality of probabilistic classifier parameters.

The food safety data associated with the first food establishment may include data from one or more data sources associated with the first food establishment, including past health department inspection data, observational data, self-audit data, cleaning machine data, chemical product dispenser data, food service machine data, hand hygiene compliance data, and any other data that may be captured or related to food safety performance at a food service establishment.

Further during the prediction phase, the computing device maps the food safety data associated with the first food establishment to a set of actionable factors to create an actionable factor data set associated with the first food establishment (270). The computing device may store one or more mappings, such as data-factor mappings 56 as shown in FIG. 1A, that relate individual data points of the food safety data received from one or more data sources to a set of actionable factors. The food safety data from the one or more data sources may be mapped to the set of actionable factors to create the actionable factor data set.

Further during the prediction phase, the computing device determines a probability that the first food establishment will fail the integer number of the standardized health department inspection questions on its next health department inspection (272). For example, the computing device may determine, by providing the actionable factor data set to a trained neural network, a probability that the food establishment will fail an integer number of standardized health department questions. In other words, the computing device may determine a probability that the first food establishment will fail the integer number of the standardized health department inspection questions based on the actionable factor data set and the plurality of probabilistic classifier parameters determined during the training phase.

Further during the prediction phase, the computing device generates, for display on a user computing device, an indication of the determined probability (274). For example, the computing device may generate, for display on a user computing device, a graphical user interface including an indication of the probability that the first food establishment will fail the integer number of standardized health department inspection questions. The indication of the determined probability may be displayed, for example, on a graphical user interface such as any of those shown in FIGS. 4-8. The indication may include text and/or any type of graphical user interface element, such as gauge icons 102, 122, 132, and/or 142 as shown in FIGS. 4-8.

In some examples, the integer number of standardized health department inspection questions is an integer in a range between 1 and 10. This number may be chosen or customized such that a food establishment or corporate entity may set what they determine to be an unacceptable number of failed standardized questions on a health department inspection, or other number that they want to be notified about.

In some examples, the probabilistic classifier may include an ensemble of random forest classifiers or other type of decision tree classifier. It shall be understood, however, that any machine learning algorithms or techniques may be used, such as Poisson regression, logistic regression, lasso regression, gradient boosting machines, and that the disclosure is not limited in this respect.

In some examples, the first data set of each training pair further includes a geospatial training data set associated with the one of the plurality of food establishments. For example, geospatial training data includes data from other food establishments that are geographically close to the food establishment. This geospatial training data may be relevant in that certain types of violations may be more prevalent (and thus more likely to occur) in certain geographic locations. Therefore, the geospatial training data may be useful in predicting certain types of violations in that they take into account violations at food establishments located relatively near the food establishment.

In some examples, the computing device need not perform the training steps (252, 254) each time a probability that a food establishment will fail an integer number of standardized health department inspection questions is to be determined. For example, once the probabilistic parameters have been determined in a training phase, those probabilistic parameters may be stored by the computing the device, such as in predictive risk module 33 of FIG. 1B, and the computing device may hence forth perform only the steps of the predicting phase (256, 258 and 260).

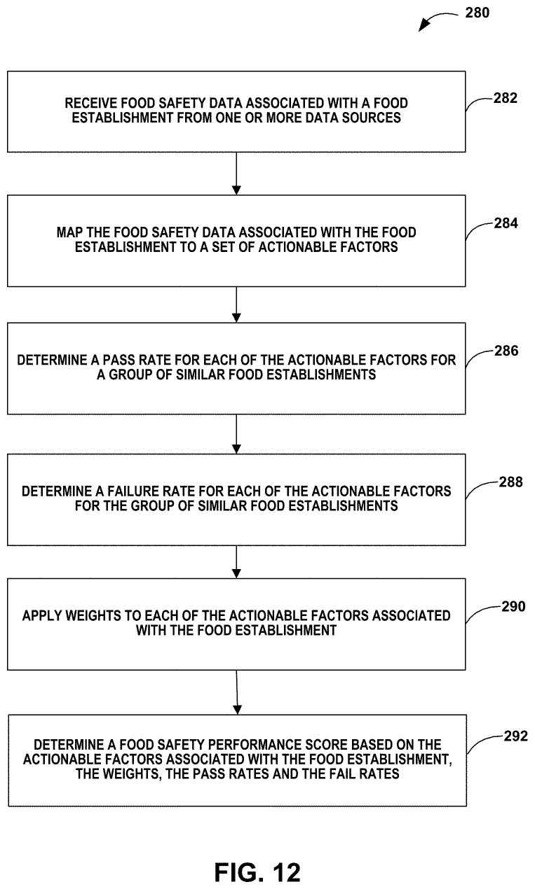

FIG. 12 is a flowchart illustrating an example process (280) by which a computing device, may generate a performance score based on food safety data from one or more data sources for a food establishment (or a group of food establishments). The example process (280) may be stored as computer-readable instructions, such as in performance score module 31 of FIG. 1B, that, when executed by a computing device, such as server computer device 30 of FIG. 1A, cause the computing device to determine a performance score for a food establishment or a group of food establishments. Example equations that may be employed during example process (280) are described above with respect to the performance score calculations.

Computing device receives food safety data associated with a food establishment from one or more data sources (282). The food safety data associated with the each of the plurality of food establishments may include data from one or more data sources including past health department inspection data, observational data, self-audit data, cleaning machine data, chemical product dispenser data, food service machine data, hand hygiene compliance data, and any other data that may be captured or related to food safety performance at a food service establishment.

The computing device maps the food safety data associated with the food establishment to a set of actionable factors to create an actionable factor data set associated with the food establishment (284). This is similar to that described above with respect to process step (270) of process (266) as shown in FIG. 11B. For example, the computing device may store one or more mappings, such as data-factor mappings 56 as shown in FIG. 1A, that relate individual data points of the food safety data received from one or more data sources to a set of actionable factors. The food safety data from the one or more data sources may be mapped to the set of actionable factors to create the actionable factor data set.

The computing device determines a pass rate for each of the actionable factors for a group of similar food establishments (286). The group of similar food establishments may include those of a same type. Types of food establishments may include, for example, full-service restaurants, quick serve restaurants, fast food restaurants, cafeterias, lodging, long-term care facilities, etc. Thus, if a food establishment for which a performance score is to be determined is a full-service restaurant, the group of similar food establishments used for purposes of step (286) would include one or more other full-service restaurants.

The computing device determines a fail rate for each of the actionable factors for a group of similar food establishments (288). As with the pass rate, the group of similar food establishments includes those of a same type.

The pass rate (and likewise the fail rate) for each actionable factor for the group of similar food establishments includes the total number of “passes” (or “fails”) for each actionable factor divided by the total number of food establishments associated with that actionable factor. As the data sources from which food safety data are not necessarily the same for all food establishments some food establishments will include food safety data mapped to a particular actionable factor and some will not. Thus, the pass rate (and likewise the fail rate) for each actionable factor takes into account only those food establishments having food safety data mapped to that actionable factor.

The computing device may also apply a weight to each actionable factor associated with the food establishment (290).

The computing device determines a food safety performance score based on the actionable factors associated with the food establishment, the pass rates for each of those actionable factors for the group of similar food establishments and the fail rates for each of those actionable factors for the group of similar food establishments (292).

For example, for all the sites that score values must be calculated for, factor level pass rate and failure rate values can be found by performing a weighted average calculation on each site's corresponding pass rate and fail rate values. This uses each site's time values as weights. If only a single site is of interest, this weighted average will not change the pass rate and failure rates.

The amount of positive evidence for the performance score calculation is a function of the calculated pass rate, the expected pass rate, subject matter expertise weighting, time weighting of the actionable factor, and the weighting of the data source. Likewise, the negative evidence for the score calculation is a function of the fail rate, expected fail rate, subject matter expertise weighting, time weighting, and data source weighting.

The performance score calculation is designed to ensure the resulting performance score takes into account both positive and negative evidence for the food establishment (e.g., positive evidence includes data indicating that the food establishment “passed” a particular actionable factor, and negative evidence includes data indicating that the food establishment “failed” a particular actionable factor), be on a scale between 0-100, with 50 as a balanced score, and to create comparable scores, even if the sites in question have differing data sets. To achieve this comparison capability, consistent units of measuring risk are used in scoring process. Specifically, the scoring logic accounts for translating the information across different data sets into common units of measurement for food safety management (e.g., mapping food safety data associated with a food establishment from one or more data sources to a set of actionable factors); qualification and calibration of an observed issue based on typical observation failures and passes across the market (e.g., pass rate and fail rate for a group of similar food establishments); and scaling of the risk according to criticality (assigning weights to each of the actionable factors).

In another example, a computing device (such as server computing device 30 of FIG. 1A) may map raw text corresponding to food safety for a food establishment to a set of actionable factors. In a first example, a computing device may load raw text from a relevant data source. This may include raw text from health department inspections, tech service audits, field service visits (e.g., cleaning or pest), self-audit checklists, social media data, etc. The raw text may be pre-processed, such as by removing uppercase letters, removing stop words, removing sparse terms, removing punctuation, expanding abbreviations, etc. A subject matter expert may manually identify portions of the processed text that apply to an actionable factor. Use an algorithm to form correlations between the raw text and the assigned actionable factor categories resulting in an actionable factor prediction model. Various algorithms may be able to accomplish this at differing levels. Some example algorithms include key word identification, random Forests, fastText, or any other appropriate machine learning model. During a predictive phase, the computing device may obtain new raw text data associated with a food establishment, and may apply the actionable factor prediction model to the new text data to map the raw text data to the appropriate actionable factor for the food establishment.

As another example, the computing device may load raw text from a relevant data source as described above. The raw text may be pre-processed, such as by segmenting phrases, removing uppercase letters, removing stop words, removing sparse terms, removing punctuation, expanding abbreviations, etc. The computing device may then use an algorithm to form patterns in the raw text. Various algorithms may be able to accomplish this at differing levels. An example of this would be the published algorithm Latent Dirichlet Allocation. A subject matter expert may manually assess the found patterns identifying those patterns that correspond to one or more actionable factors. During a predictive phase, the computing device may obtain new raw text data associated with a food establishment, and may apply the actionable factor prediction model to the new text data to map the raw text data to the appropriate actionable factor for the food establishment.

The mapped actionable factors may be used as part of determining a performance score and/or predictive scoring and predictive risk (i.e., the probability that the food establishment will fail an integer number of standardized health department inspection questions on its next health department inspection. Table 4 shows examples of mapping raw text to actionable factors. The highlighted portions of the raw text are those identified as including the relevant food safety data for mapping purposes.

TABLE 4

| Service Technician Violation Notes | Tags |
|---|---|
| Food Contact Surfaces-Cleaned/Sanitized/Good Repair. The soft drink dispenser | SodaMachine- |
| located in the server station has adhering foreign material. | Interior-Mold |
| Noted numerous pans/metal containers on shelving for “clean and sanitized” | Utensils- |
| items to have old food product on food contact surfaces indicating lack of proper | Surface-Dirty |
| wash, rinse, and sanitizing procedures. Manager stated all potware is sent | |
| through dishmachine and 3-compartment sink is not used. Inadequate | |
| cleaning/sanitizing procedure. A dishmachine is not sufficient for pot washing to | |
| remove grime/grease as indicated by condition of metal containers. Adequate | |
| procedures are to be instituted to ensure proper wash, rinsing and sanitizing is | |
| conducted. All potware to be rewashed, rinsed, and sanitized. | |
| Clean ice making machine to prevent contamination of the ice. Observed slime | IceMachine- |
| on rim of ice shoot. Ice is bagged and used to cool seafood. Machine being | Interior-Dirty |
| cleaned on site. | |

In another example, a computing device (such as server computing device 30 of FIG. 1A) may identify anomalies in the food safety data for a food establishment. For example, a computing device may load a reoccurring value data set that contains historical data for a specific time frame for a food establishment. This may include sales of a product per month or hand hygiene product dispenses over a period of time for a food establishment. The computing device may apply a statistical method that can be used to identify deviations from previously observed behavior. In other words, the computing device may apply a statistical method to identify outliers in the historical data. For example, the computing device could apply an algorithm such as a Tukey fence or a Poisson model to identify outliers in the historical data for the food establishment. The computing device may create thresholds from the model that identify abnormal changes in the reoccurring value.

The computing device may obtain new reoccurring values for the food establishment, and compare the new reoccurring values to the created thresholds. If a reoccurring value is shown to be abnormal, the computing device may generate one or more notifications. For example, in the case of lack of product purchase over an extended period of time, the computing device may generate a notification including a suggested action. The suggested action may be, for example, to verify there is still product available. As another example, if too few hand hygiene dispenses are observed, the computing device may generate a notification that more hand hygiene training should be provided. This process may be repeated periodically to create more up to date thresholds.

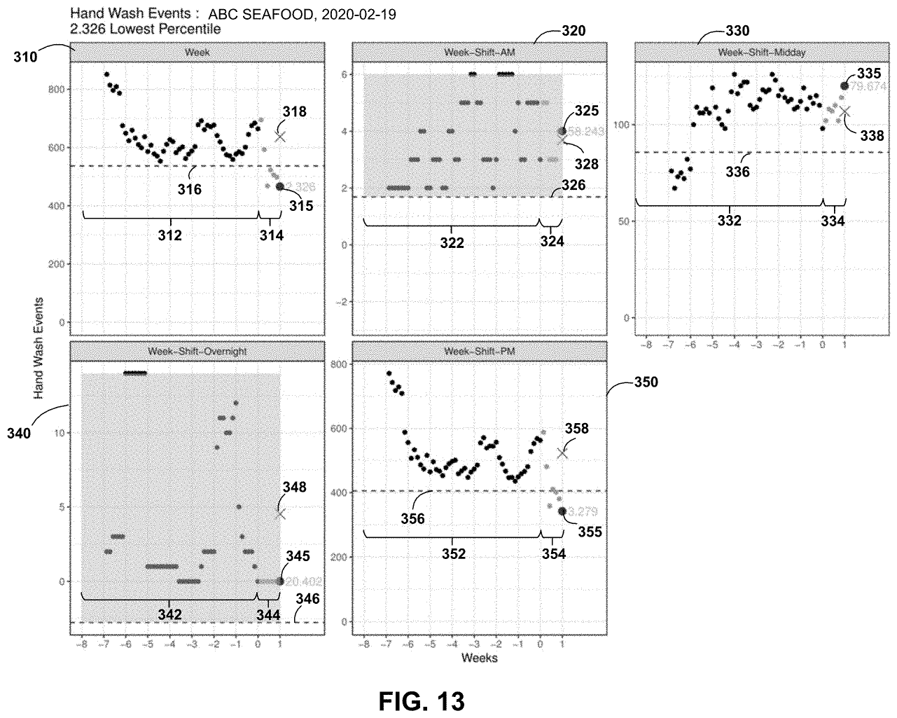

FIG. 13 are graphs 310, 320, 330, 340, and 350 including example chemical product dispense event data associated with an establishment in accordance with one or more techniques of the present disclosure. Graphs 310, 320, 330, 340, and 350 also include example predicted chemical product dispense event data determined in accordance with the techniques of the present disclosure. In these examples, the chemical product dispense event data is hand hygiene event data from one or more hand hygiene product dispensers associated with the establishment. However, it shall be understood that monitoring of hand hygiene events is but one example of chemical product dispensing which may be monitored in accordance with one or more techniques of the present disclosure, and that the disclosure is not limited in this respect.

Graph 310 shows example historical hand hygiene event data (e.g., the number of detected hand hygiene dispense events) by week for a first time frame 312, actual hand hygiene event data by week for a second time frame subsequent to the first time frame 314, 315, a hand hygiene event threshold 316 determined based on the historical hand hygiene event data for the first time frame, and predicted hand hygiene event data for the second time frame 318. Similarly, graphs 320, 330, 340 and 350 show the same data as shown in graph 310 but, rather than including all hand hygiene event data for each day of the week as with graph 310, the data is further divided by shift time, such as Week-Shift-AM graph 320, Week-Shift-Midday graph 330, Week-Shift-Overnight graph 340 and Week-Shift-PM graph 350.

As can be seen in each of graphs 310, 320, 330, 340, and 350, the graphs include historical hand hygiene event data for a first time frame, indicated by reference numerals 312, 322, 332, 342, and 352. In this example, the first time frame is 8 weeks (indicated as week −8 to week −1). The graphs also include predicted hand hygiene event data for a second time frame, wherein the second time frame is subsequent to the first time frame. In this example, the second time frame is the next subsequent week (indicated as week 0). In accordance with the techniques of the present disclosure, a computing device may predict hand hygiene event data for the second time frame based on hand hygiene event data for the first time frame. Examples of predicted hand hygiene data for each of graphs 310, 320, 330, 340 and 350 are shown as an “X” and are indicated by reference numerals 318, 328, 338, 348 and 358, respectively. The predicted hand hygiene event data value(s) may be determined in any number of ways, and it shall be understood that the disclosure is not limited in this respect. For example, the computing device may determine a mean of the hand hygiene event data for the first period of time, a median (average) of the hand hygiene event data for the first period of time, or use any other method of predicting a future value of the hand hygiene event data for the second time frame based on historical hand hygiene event data for the first predetermined period of time.

For each type of data aggregation shown the graphs of FIG. 13, a computing device (such as any one or more of computing device(s) 22 and/or 30 as shown in FIG. 1) may determine one or more hand hygiene event threshold(s) based on the hand hygiene event data for the first predetermined time frame. Example thresholds for each of graphs 310, 230, 330, 340, and 350 are illustrated by dashed lines 316, 326, 336, 346, and 356, respectively. The hand hygiene event data threshold(s) may be determined in any number of ways, and it shall be understood that the disclosure is not limited in this respect. For example, the computing device may use any type of statistical method to determine the hand hygiene event threshold including, but not limited to, t-distribution, autoregressive integrated moving average (ARIMA), Poisson regression, negative binomial regression, etc.

FIG. 13 further shows that each graphs 310, 320, 330, 340 and 350 also include the actual hand hygiene event data for the second time frame, as indicated by reference numerals 314, 324, 334, 344, and 354, respectively. The large data point indicated by reference numerals 315, 325, 335, 345, and 355 indicate the actual hand hygiene data on the same day as the predicted hand hygiene data 318, 328, 338, 348, and 358, respectively.

In accordance with one or more techniques of the present disclosure, a computing device may compare the actual hand hygiene event data with the predicted hand hygiene event data and/or the threshold and determine one or more hand hygiene scores or ratings for the establishment. For example, in graph 310, the actual number of hand hygiene dispense events 315 was less than the predicted number of dispense events 318. Similarly, the actual number of hand hygiene dispense events 315 was less than the threshold 316. As shown by graphs 320 and 330, the actual number of hand hygiene dispense events 325, 335 was above both the predicted number 328, 338 and the threshold 326, 336 for week-shift-am and week-shift-midday, respectively, whereas graph 350 shows that the week-shift-pm number of dispense events 355 for the same time period was below both the predicted number 358 and the threshold 356. Depending upon the difference between the values, the computing device may assign one or more classifications, ratings, or scores indicative of the hand hygiene performance of the establishment on that particular day. This may help an establishment gain insight into hand hygiene dispense event performance and also to compare hand hygiene performance during different shifts or other relevant time periods.

For example, the computing device may assign numerical scores indicative of hand hygiene performance as compared to the prediction and/or the threshold. The computing device may assign a rating and/or color indicative of the relative level of hand hygiene performance as compared to the prediction and/or the threshold, such as green=excellent, light green=good, yellow=above average, orange=below average, red=poor, and dark red=very poor. As another example, the computing device may assign a score or rating such as “less than normal,” “normal,” or “above normal.” This data may be displayed on one or more dashboards such as any of those shown in FIGS. 4-8. In this way, the graphical user interface enables a user to easily view and understand, on a per week, per day, and/or a per shift basis, where an establishment is performing well or performing poorly in terms of hand hygiene dispense events and/or sanitizer dispense events. This may further enable an establishment to diagnose and address problems related to food safety, infection risk, and thus to increase their performance score and/or lower their predictive risk on health department questions related to hand hygiene performance at the establishment, or to help reduce risk of infection transmission in a healthcare setting.

In addition, a computing device may further analyze the hand hygiene event data associated with the first establishment with respect to hand hygiene event data associated with one or more other selected establishments. This may allow a corporate entity, for example, to gain insight into hand hygiene practices at one or more corporate locations, compare and contrast hand hygiene event data across one or more locations and/or identify where further training and/or mitigation processes aimed at addressing any perceived insufficiencies in hand hygiene performance should be implemented.

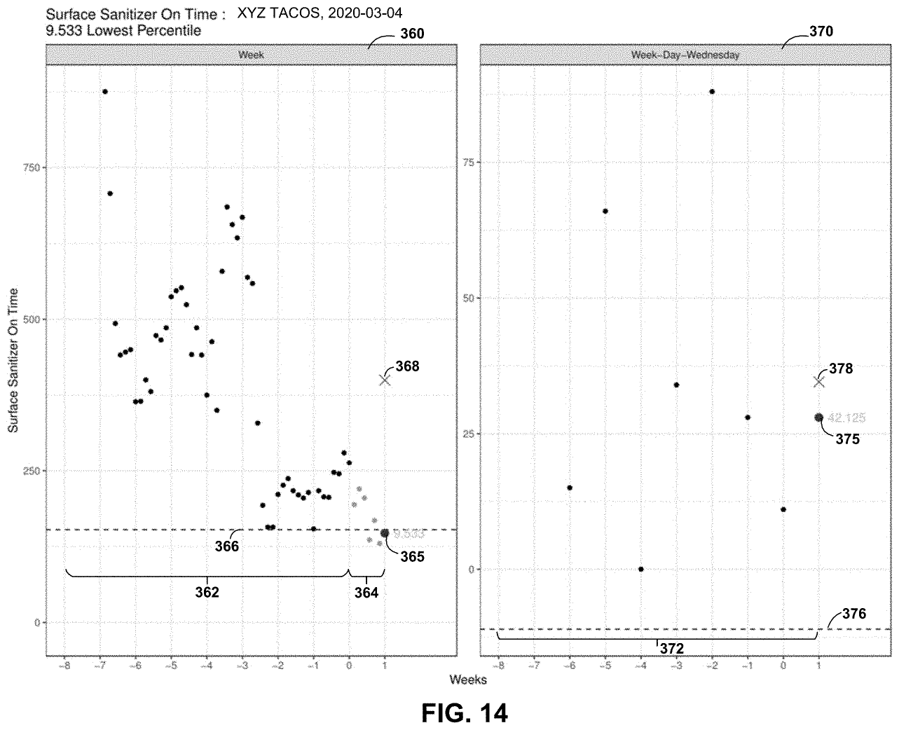

FIG. 14 are graphs 360 and 370 including example chemical product dispense event data associated with an establishment in accordance with the techniques of the present disclosure. Graphs 360 and 370 also include example predicted chemical product dispense event data determined in accordance with the techniques of the present disclosure. In these examples, the chemical product dispense event data is sanitizer dispense event data from one or more surface sanitizer product dispensers associated with the establishment. However, it shall be understood that monitoring of sanitizer dispense events is but one example of chemical product dispensing which may be monitored in accordance with one or more techniques of the present disclosure, and that the disclosure is not limited in this respect.

In this example, graph 360 shows sanitizer dispense event data by week expressed in terms of the “on time” or total amount of time the sanitizer dispenser actuator was “ON” for each detected sanitizer dispense event, and accumulated for a particular time period (in this case, days of the week). Graph 360 shows historical sanitizer dispense event data by week for a first time frame 362, actual sanitizer dispense event data by week for a second time frame subsequent to the first time frame 364, 365, a sanitizer dispense event threshold 366 determined based on the sanitizer dispense event data for the first time frame, and predicted sanitizer dispense event data by week for the second time frame 368. Similarly, graph 370 shows the same data as shown in graph 360 but, rather than including all sanitizer dispense event data for each day of the week as with graph 360, the data is further by day, which graph 370 showing the sanitizer dispense event data for week day Wednesday. Sanitizer dispense event data may also be aggregated with respect with one or more different times of the day or week as shown by the graphs shown in FIG. 13.

In some examples, the “on time” or amount of time that the dispenser actuator is ON may be correlated to the amount (e.g., volume) of sanitizer dispensed. For example, certain automated sanitizer dispensers, such as those for sanitizing food contact surfaces, sinks and/or other surfaces to be sanitized, include an “ON” button, switch, or other type of actuator which, when actuated by a user, causes a liquid sanitizer to be dispensed at a predetermined flow rate. By determining the amount of time that the sanitizer dispenser actuator was actuated, the volume of sanitizer dispensed may be determined. The amount of chemical product dispensed may also be tracked and compared with historical data to gain insight into chemical product usage at the establishment.

As can be seen in each of graphs 360 and 370, the graphs include historical sanitizer dispense event data (dispenser on time in these examples) for a first time frame, indicated by reference numerals 362 and 372. In this example, the first time frame is 8 weeks (indicated as week −8 to week −1). The graphs also include predicted sanitizer dispense event data for a second time frame subsequent to the first time frame. In this example, the second time frame is the next subsequent week (indicated as week 0). In accordance with the techniques of the present disclosure, a computing device may predict sanitizer dispense event data for the second time frame based on the historical sanitizer dispense event data for the first time frame. Examples of predicted sanitizer dispense event data for each of graphs 360 and 370 are shown as an “X” and are indicated by reference numerals 368 and 378, respectively. The predicted sanitizer dispense event data value(s) may be determined in any number of ways, and it shall be understood that the disclosure is not limited in this respect. For example, the computing device may determine a mean of the sanitizer dispense event data for the first time frame, a median (average) of the sanitizer dispense event data for the first time frame, or use any other method of determining a threshold representative of the sanitizer dispense event data for the first time frame. In addition, the length of the first time frame or the particular dates/times included in the first time frame may be adjusted so as to gain different insights into sanitizer dispenser usage at the establishment.

For each type of data aggregation shown the graphs of FIG. 14, a computing device may determine one or more sanitizer dispense event threshold(s) based on the sanitizer dispense event data for the first time frame. Example thresholds for each of graphs 360 and 370 are illustrated by dashed lines 366 and 376, respectively. The sanitizer dispense event data threshold(s) may be determined in any number of ways, and it shall be understood that the disclosure is not limited in this respect. For example, the computing device may use any type of statistical method to determine the sanitizer dispense event threshold including, but not limited to, t-distribution, autoregressive integrated moving average (ARIMA), Poisson regression, negative binomial regression, etc.

Graph 360 also includes the actual sanitizer dispense event data for the second time frame, as indicated by reference numeral 364. The large data point indicated by reference numerals 365 and 375 indicate the actual sanitizer dispense event data on the same day as the predicted sanitizer dispense event data 368 and 378, respectively.

In accordance with one or more techniques of the present disclosure, a computing device may compare the actual sanitizer dispense event data with the predicted sanitizer dispense event data and/or the threshold and determine one or more sanitizer dispense scores or ratings for the establishment. For example, in graph 360, the on time for the sanitizer dispense events 365 was significantly less than the predicted on time for sanitizer dispense events 368 and slightly less than the threshold 366. Depending upon the difference between the values, the computing device may assign one or more classifications, ratings, or scores indicative of sanitizer dispense performance of the establishment on that particular day. This may help an establishment gain insight into sanitizer dispense or usage performance and also to compare sanitizer dispense or usage performance during different shifts or other relevant time periods.

For example, the computing device may assign numerical scores indicative of sanitizer dispense event performance or sanitizer usage as compared to the prediction and/or the threshold. The computing device may assign a rating and/or color indicative of the relative level of sanitizer dispense event performance as compared to the prediction and/or the threshold, such as green=excellent, light green=good, yellow=above average, orange=below average, red=poor, and dark red=very poor. As another example, the computing device may assign a score or rating such as “less than normal,” “normal,” or “above normal.” This data may be displayed on one or more dashboards such as any of those shown in FIGS. 4-8. In this way, the graphical user interface enables a user to easily view and understand, on a per week, per day, and/or a per shift basis, where an establishment is performing well or performing poorly in terms of sanitizer usage and/or sanitizer dispense events. This may further enable an establishment to diagnose and address problems related to food safety, infection risk, and thus to increase their performance score and/or lower their predictive risk on health department questions related to sanitizer usage at the establishment, or to help reduce risk of infection transmission in a healthcare setting.

In addition, a computing device may further analyze the sanitizer dispense event data associated with the first establishment with respect to sanitizer dispense event data associated with one or more other selected establishments. This may allow a corporate entity, for example, to gain insight into sanitizer usage practices at one or more corporate locations, compare and contrast sanitizer dispense event data across one or more locations and/or identify where further training and/or mitigation processes aimed at addressing any perceived insufficiencies in sanitizer usage should be implemented.

In some examples, in accordance with the present disclosure, a computing device may analyze the historical chemical product dispense event data, such hand hygiene product dispense event data and/or sanitizer dispense event data, to exclude outliers or other extreme values that deviate from the data, and that may lead to incorrect prediction(s) of future dispense event data or determination of the threshold(s). For example, the hand hygiene context, graph 340 of FIG. 13 includes dispense event data from an overnight shift, in which few people are working but during which a small number of dispense events may still occur. In certain circumstances, it may be desirable to exclude the data in this example as it may lead to inaccuracies in predictions for other time periods or for the overall prediction(s). As another example, in the sanitizer dispense context, a typical sanitizer dispense may involve filling of a spray bottle or dispensing sanitizer into a pail. However, occasionally in a food service context, a large amount of sanitizer may be used when filling a 3-compartment sink. It may therefore be desirable to exclude data points having an exceeding long “on time” corresponding to these relatively less frequent events. Exclusion of such outliers that diverge from the overall patterns in the data in accordance with one or more techniques of the present disclosure may lead to more accurate predictions of future chemical product dispense event data, such as predicting a number of hand hygiene dispense events at some point in the future based on historical hand hygiene dispense event data, or predicting a number of sanitizer dispense events, sanitizer dispenser on times, or volume of sanitizer dispensed based on historical sanitizer dispense event data. Such techniques may also lead to and more accurate characterization of current or future chemical product dispense performance as compared to historical chemical product dispenser performance, which may further lead to better and more accurate insights into chemical product dispenser performance at the establishment.

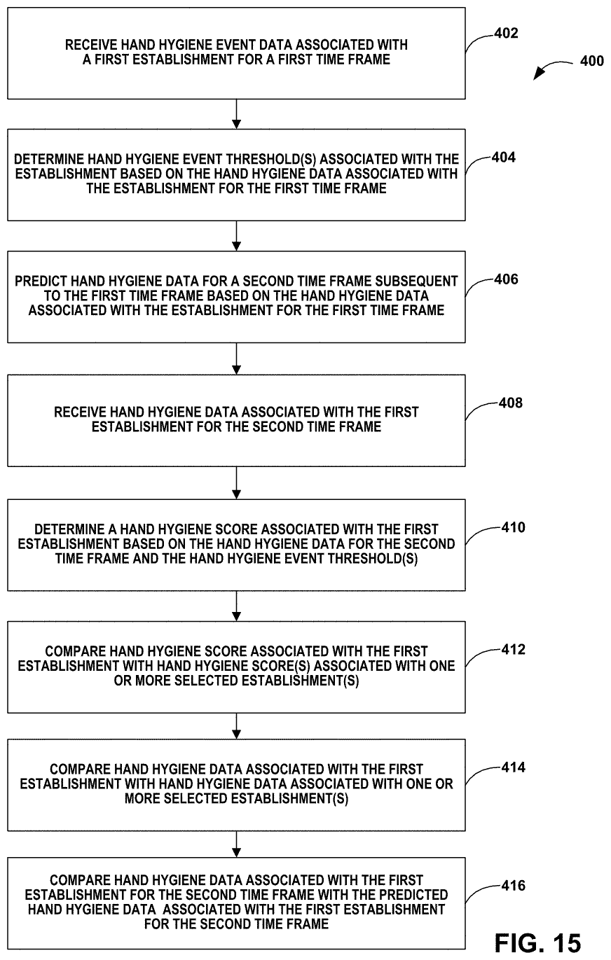

FIG. 15 is a flowchart illustrating an example process (400) by which a computing device may analyze chemical product dispense event data for an establishment in accordance with the techniques of the present disclosure. In this example, the chemical product dispense event data is hand hygiene dispense event data received from one or more hand hygiene product dispensers associated with an establishment. However, it shall be understood that monitoring of hand hygiene events is but one example of chemical product dispensing which may be monitored in accordance with one or more techniques of the present disclosure, and that the disclosure is not limited in this respect.

A computing device, such as any one or more of server computing device(s) 30 or user computing device 22 as shown in FIG. 1A, may execute example process (400). In some examples, process (400) may include computer program code stored in analysis module 32 and/or performance score module 31 and/or predictive risk module 33 as shown in FIGS. 1A and 1B. In other examples, server computing device(s) 30 and/or user computing devices (22) may include, in addition or alternatively, processing circuitry configured to execute example process (400).

As shown in the example of FIG. 15, a computing device receives hand hygiene event data associated with a first establishment for a first time frame (402). For example, the first time frame may include one or weeks during which hand hygiene dispense events were monitored at the establishment. In the example described herein with respect to FIG. 13, for example, the first time frame for which hand hygiene event data was received was 8 weeks.

The computing device determines one or more hand hygiene event threshold(s) associated with the establishment based on the hand hygiene data associated with the establishment for the first time frame (404). For example, the computing device may use any type of statistical analysis to identify a threshold representative of the hand hygiene event data associated with the establishment for the first time frame. In general, the threshold sets an expected value or range of values for future hand hygiene dispense event performance for an establishment based on historical hand hygiene dispense event data for the establishment. In other words, the threshold attempts to set a value or range of values by which dispense event data for one or more future time frames may be compared to gain insight into hand hygiene performance as compared to past hand hygiene performance, or between one time period and another time period.

The computing device predicts hand hygiene event data for a second time frame subsequent to the first time frame based on the hand hygiene event data associated with the establishment for the first time frame (406). In general, the prediction attempts to set an expected value or range of values for a predicted number of hand hygiene dispense events performance at the establishment at some future time based on historical hand hygiene dispense event data for the establishment. For example, the prediction may be an average or mean of the hand hygiene data from the first time frame, or some other method of predicting hand hygiene data for the second time frame based on historical hand hygiene data for the first time frame.

The computing device receives hand hygiene data associated with the establishment for the second time frame (408). For example, the second time frame may include one or weeks during which hand hygiene dispense events were monitored at the establishment. In the example described herein with respect to FIG. 13, for example, the second time frame for which hand hygiene event data was received was a single week immediately following the eight weeks included in the first time frame.

The computing device may determine a hand hygiene score associated with the establishment based on the hand hygiene data for the second time frame and the hand hygiene event threshold(s) (410). For example, the computing device may compare the number of hand hygiene dispense events that occurred during one or more days or during one or more shifts during the second time frame with corresponding threshold(s). If the number of hand hygiene dispense events meets or exceeds the corresponding threshold, the computing device may assign a score of “satisfactory” or any other score or indication that the threshold was satisfied. If the number of hand hygiene dispense events does not exceed the corresponding threshold(s), the computing device may assign a score of “unsatisfactory” or any other score or indication that number of hand hygiene dispense events during the corresponding interval did not satisfy the threshold.

The computing device may compare the hand hygiene score associated with the first establishment with one or more hand hygiene score(s) associated with one or more selected establishment(s) (412). The computing device may further generate, for display on a user computing device, hand hygiene scores, ratings, and/or data for the establishment in comparison with hand hygiene scores and/or data for the one or more selected establishments, or display the comparisons as one or more graphical elements, as shown and described herein with respect to FIGS. 4-8.

The computing device may compare hand hygiene data associated with the first establishment with hand hygiene data associated with one or more selected establishments (414). This may allow a user to view and compare the number of hand hygiene events occurring at the establishment in comparison with the number of hand hygiene dispense events occurring at the other selected establishments.

The computing device may compare hand hygiene data associated with the first establishment for the second time frame with the predicted hand hygiene data associated with the establishment for the second time frame (416). This may allow a user to view and compare the number of hand hygiene events occurring at the establishment with the predicted number of hand hygiene events. For example, the computing device may compare the number of hand hygiene dispense events that occurred during one or more days or during one or more shifts during the second time frame with the predicted number of dispense events for those time period(s). If the number of hand hygiene dispense events is less than predicted, the computing device may generate a notification for display on the user computing device. The computing device may further generate, for display on the user computing device, one or more recommended action aimed at addressing or understanding the lower than predicted number of hand hygiene dispense events, such as shown and described herein with respect to FIGS. 4-8. The computing device may further generate, for display on the user computing device, the hand hygiene event threshold, the hand hygiene data, the ratings and/or scores, the predicted number of hand hygiene events, and any other hand hygiene data, such as shown and described herein with respect to FIGS. 4-8 and/or FIG. 13.

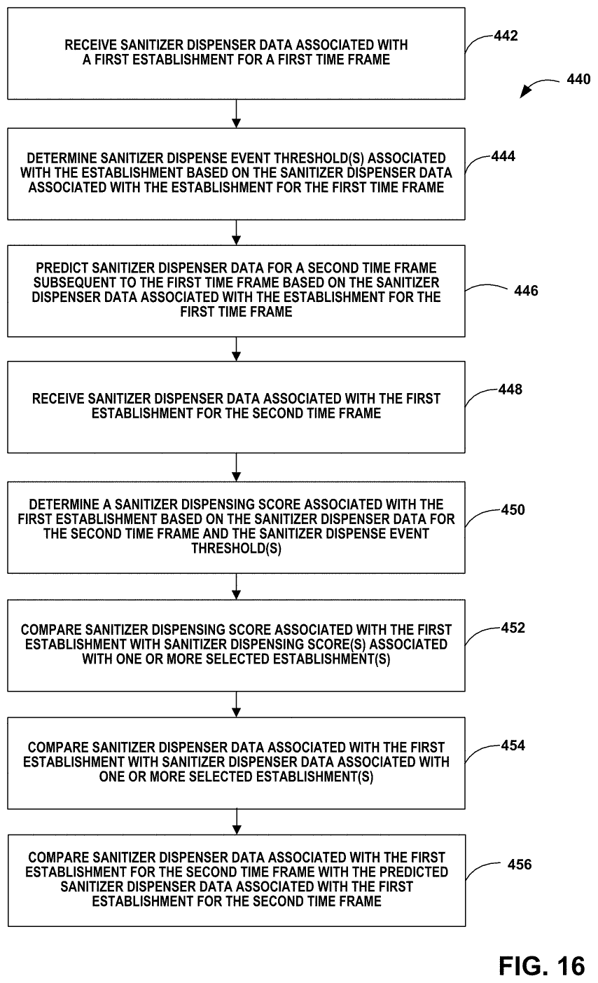

FIG. 16 is a flowchart illustrating an example process (440) by which a computing device may analyze sanitizer dispense event data for establishment in accordance with the techniques of the present disclosure. In this example, the chemical product dispense event data is sanitizer dispense event data received from one or more surface sanitizer dispensers associated with an establishment. However, it shall be understood that monitoring of sanitizer dispense events is but one example of chemical product dispensing which may be monitored in accordance with one or more techniques of the present disclosure, and that the disclosure is not limited in this respect.

A computing device, such as any one or more of server computing device(s) 30 or user computing device 22 as shown in FIG. 1A, may execute example process (440). In some examples, process (440) may include computer program code stored in analysis module 32 and/or performance score module 31 and/or predictive risk module 33 as shown in FIGS. 1A and 1B. In other examples, server computing device(s) 30 and/or user computing devices (22) may include, in addition or alternatively, processing circuitry configured to execute example process (440).

As shown in the example of FIG. 16, a computing device receives sanitizer dispense event data associated with a first establishment for a first time frame (442). The sanitizer dispense event data may be expressed in terms of the “on time” of one of more sanitizer dispensers associated with the establishment. In some examples, the first time frame may include one or weeks during which sanitizer dispense events were monitored at the establishment. In the example described herein with respect to FIG. 14, for example, the first time frame for which sanitizer dispense event data was received was 8 weeks.

The computing device determines one or more sanitizer dispense event threshold(s) associated with the establishment based on the sanitizer dispense event data associated with the establishment for the first time frame (444). For example, the computing device may use any type of statistical analysis to identify a threshold representative of the sanitizer dispense event data associated with the establishment for the first time frame. In general, the threshold sets an expected value or range of values for future sanitizer dispense event performance for an establishment based on historical sanitizer dispense event data for the establishment. In other words, the threshold attempts to set a value or range of values by which dispense event data for one or more future time frames may be compared to gain insight into sanitizer usage as compared to past sanitizer usage, or between one time period and another time period.

The computing device predicts sanitizer dispense event data for a second time frame subsequent to the first time frame based on the sanitizer dispense event data associated with the establishment for the first time frame (446). In general, the prediction attempts to set an expected value or range of values for the on time of sanitizer dispensers at the establishment at some future time based on historical sanitizer dispense event data for the establishment.

The computing device receives sanitizer dispense event data associated with the establishment for the second time frame (448). For example, the second time frame may include one or weeks during which sanitizer dispense events were monitored at the establishment. In the example described herein with respect to FIG. 13, for example, the second time frame for which sanitizer dispense event data was received was a single week immediately following the eight weeks included in the first time frame.

The computing device may determine a sanitizer usage score associated with the establishment based on the sanitizer dispense event data for the second time frame and the sanitizer dispense event threshold(s) (450). For example, the computing device may compare the number of sanitizer dispense events and/or the on time corresponding to one or more dispense events that occurred during one or more days or during one or more shifts during the second time frame with corresponding threshold(s). If the number of sanitizer dispense events and/or the on time for the dispense events satisfies the corresponding threshold, the computing device may assign a score of “satisfactory” or any other score or indication that the threshold was satisfied. If the number of sanitizer dispense events does not satisfy the corresponding threshold(s), the computing device may assign a score of “unsatisfactory” or any other score or indication that number of sanitizer dispense events or the dispenser on time during the corresponding interval did not satisfy the threshold.

The computing device may compare the sanitizer usage score associated with the first establishment with one or more sanitizer usage score(s) associated with one or more selected establishment(s) (452). The computing device may further generate, for display on a user computing device, sanitizer usage scores, ratings, and/or data for the establishment in comparison with sanitizer usage scores and/or data for the one or more selected establishments, or display the comparisons as one or more graphical elements, as shown and described herein with respect to FIGS. 4-8.

The computing device may compare sanitizer dispense event data associated with the first establishment with sanitizer dispense event data associated with one or more selected establishments (454). This may allow a user to view and compare the number of sanitizer dispense events occurring at the establishment in comparison with the number of sanitizer dispense events occurring at the other selected establishments.

The computing device may compare sanitizer dispense event data associated with the first establishment for the second time frame with the predicted sanitizer dispense event data associated with the first establishment for the second time frame (416). This may allow a user to view a compare the number of sanitizer dispense events occurring at the establishment and/or the amount or volume of sanitizer dispensed during each sanitizer dispense event in comparison with the predicted number of sanitizer dispense events and/or predicted volume for one or more sanitizer dispense events. For example, the computing device may compare the number of sanitizer dispense events that occurred during one or more days or during one or more shifts during the second time frame with the predicted number of sanitizer dispense events for those time period(s). If the number of sanitizer dispense events is less than predicted, the computing device may generate a notification for display on the user computing device. The computing device may further generate, for display on the user computing device, one or more recommended actions aimed at addressing or understanding the lower than predicted number of sanitizer dispense events, or the less than predicted amount or volume of sanitizer dispensed, such as shown and described herein with respect to FIGS. 4-8. The computing device may further generate, for display on the user computing device, the sanitizer dispense event threshold(s), the sanitizer dispense event data, the ratings and/or scores, the predicted number of sanitizer dispense events, the predicted volume of one or more sanitizer dispense events, and any other sanitizer dispense event data, such as shown and described herein with respect to FIGS. 4-8 and/or FIG. 13.

In some examples, the systems, methods, and/or techniques described herein may encompass one or more computer-readable media comprising instructions that cause a processor, such as processor(s) 202, to carry out the techniques described above. A “computer-readable medium” includes but is not limited to read-only memory (ROM), random access memory (RAM), non-volatile random-access memory (NVRAM), electrically erasable programmable read-only memory (EEPROM), flash memory a magnetic hard drive, a magnetic disk or a magnetic tape, an optical disk or magneto-optic disk, a holographic medium, or the like. The instructions may be implemented as one or more software modules, which may be executed by themselves or in combination with other software. A “computer-readable medium” may also comprise a carrier wave modulated or encoded to transfer the instructions over a transmission line or a wireless communication channel. Computer-readable media may be described as “non-transitory” when configured to store data in a physical, tangible element, as opposed to a transient communication medium. Thus, non-transitory computer-readable media should be understood to include media similar to the tangible media described above, as opposed to carrier waves or data transmitted over a transmission line or wireless communication channel.

The instructions and the media are not necessarily associated with any particular computer or other apparatus, but may be carried out by various general-purpose or specialized machines. The instructions may be distributed among two or more media and may be executed by two or more machines. The machines may be coupled to one another directly, or may be coupled through a network, such as a local access network (LAN), or a global network such as the Internet.

The systems and/or methods described herein may also be embodied as one or more devices that include logic circuitry to carry out the functions or methods as described herein. The logic circuitry may include a processor that may be programmable for a general purpose or may be dedicated, such as microcontroller, a microprocessor, a Digital Signal Processor (DSP), an Application Specific Integrated Circuit (ASIC), a field programmable gate array (FPGA), and the like.

One or more of the techniques described herein may be partially or wholly executed in software. For example, a computer-readable medium may store or otherwise comprise computer-readable instructions, i.e., program code that can be executed by a processor to carry out one of more of the techniques described above. A processor for executing such instructions may be implemented in hardware, e.g., as one or more hardware based central processing units or other logic circuitry as described above.

### Examples

Example 1. A method comprising receiving, by a computing device, food safety data associated with a food establishment from one or more data sources; mapping the food safety data associated with the food establishment to a set of actionable factors; determining, by the computing device, a food safety performance score associated with the food establishment based on the mapped actionable factors associated with the food establishment; determining, by the computing device, a predictive risk associated with the food establishment based on the food safety data from the one or more data sources associated with the food establishment; and generating, for display on a user computing device, an indication of the determined food safety performance score and the determined predictive risk.

Example 2. The method of Example 1 wherein the food safety data includes health department inspection data, observational data, cleaning machine data, and chemical product dispenser data associated with the food establishment.

Example 3. The method of Example 2 wherein observational data include observance of structural, sanitation and maintenance conditions of an establishment.

Example 4. The method of Example 2 wherein observational data includes self-audit data obtained by employees or the food establishment.

Example 5. The method of Example 1 wherein the one or more data sources include a hand hygiene compliance system associated with the food establishment, and wherein the food safety data includes hand hygiene compliance data for the food establishment.

Example 6. The method of Example 1 wherein the food safety predictive risk includes a probability that the food establishment will fail an integer number of standardized health department inspection questions.

Example 7. The method of Example 6 wherein the integer number of standardized health department inspection questions is an integer between 1 and 10.

Example 8. The method of Example 1 wherein the food establishment has an associated food establishment type, and wherein the food safety performance score is relative to other food establishments having the same associated food establishment type.

Example 9. The method of Example 1 further comprising generating a notification to a mobile computing device associated with a user recommending at least one of a training procedure or a product recommendation.

Example 10. The method of Example 1 further comprising generating, for display on a user computing device, a graphical user interface including at least one of a recommended training procedure or a product recommendation.

Example 11. The method of Examples 9 or 10 wherein the product recommendation includes one of a cleaning product or a hand washing product.

Example 12. A system comprising one or more data sources associated with a food establishment, the one or more data sources monitor parameters related to food safety performance of the food establishment; a server computing device that receives food safety data from one or more data sources associated with a food establishment, food safety data including monitored parameters related to food safety performance of the food establishment, the server computing device comprising one or more processors; a mapping that relates the food safety data associated with the food establishment to a set of actionable factors; a performance score module including computer readable instructions that, when executed by the one or more processors, cause the one or more processors to determine a food safety performance score associated with the food establishment based on the mapped actionable factors associated with the food establishment; and a predictive risk module including computer readable instructions that, when executed by the one or more processors, cause the one or more processors to determine a predictive risk associated with the food establishment based on the mapped actionable factors associated with the food establishment, wherein the computing devices further generates, for display on a user computing device, an indication of the determined food safety performance score and the determined predictive risk.

Example 13. The system of Example 12 wherein the food safety data includes health department inspection data, observational data, cleaning machine data, and chemical product dispenser data associated with the food establishment.

Example 14. The system of Example 12 wherein the one or more data sources include a hand hygiene compliance system associated with the food establishment, and wherein the food safety data includes hand hygiene compliance data for the food establishment.

Example 15. The system of Example 12 wherein the food safety predictive risk includes a probability that the food establishment will fail an integer number of standardized health department inspection questions.

Example 16. The method of Example 15 wherein the integer number of standardized health department inspection questions is an integer between 1 and 10.

Example 17. The method of Example 12 further comprising generating a notification to a mobile computing device associated with a user recommending at least one of a training procedure or a product recommendation.

Example 18. The method of Example 12 further comprising generating, for display on a user computing device, a graphical user interface including at least one of a recommended training procedure or a product recommendation.

Example 19. The method of Examples 17 or 18 wherein the product recommendation includes one of a cleaning product or a hand washing product.

Example 20. A method comprising during a training phase: receiving at a server computing device, a plurality of data set training pairs, wherein a first data set of each training pair comprises an actionable factor training data set associated with one of a plurality of food establishments, and wherein a second data set of each training pair comprises a standardized health department inspection questions training data set for the same one of the plurality of food establishments; determining, by the server computing device, a plurality of probabilistic classifier parameters based on the plurality of data set training pairs, wherein the probabilistic classifier predicts a probability that a food establishment will fail an integer number of the standardized health department inspection questions; during a prediction phase: receiving, at the probabilistic classifier at the server computing device, a food safety data set associated with a first food establishment; mapping the food safety data set to a set of actionable factors to create an actionable factor data set associated with the first food establishment; determining, by the server computing device, a probability that the first food establishment will fail the integer number of the standardized health department inspection questions based on the actionable factor data set and the plurality of probabilistic classifier parameters; and generating, by the server computing device and for display on a user computing device, an indication of the determined probability.

Example 21. The method of Example 20, wherein the integer number of standardized health department inspection questions is an integer between 1 and 10.

Example 22. The method of Example 20 wherein the probabilistic classifier is a random forest classifier.

Example 23. The method of Example 20 wherein the first data set of each training pair further includes a geospatial training data set associated with the one of the plurality of food establishments.

Example 24. The method of Example 20 wherein the first food establishment is one of the plurality of food establishments in the data set training pairs.

Example 25. The method of Example 20 wherein the first food establishments is not one of the plurality of food establishments in the data set training pairs.

Example 26. The method of Example 20 wherein the indication of the determined probability includes a graphical user interface including the probability that the first food establishment will fail the integer number of standardized health department inspection questions.

Example 27. A method comprising obtaining food safety data associated with a food establishment from one or more data sources; mapping the food safety data associated with the food establishment to a set of actionable factors to create an actionable factor data set associated with the food establishment; determining, by providing the actionable factor data set to a trained neural network, a probability that the food establishment will fail an integer number of standardized health department questions; and generating, for display on a user computing device, an indication of the determined probability.

Example 28. A method comprising receiving food safety data associated with a food establishment from one or more data sources; mapping the food safety data associated with a food establishment to a set of actionable factors; determining a pass rate for each of the actionable factors for a group of similar food establishments; determining a failure rate for each of the actionable factors for the group of similar food establishments; applying weights to each of the actionable factors associated with the food establishment; and determining a food safety performance score based on the actionable factors associated with the food establishment, the weights, the pass rates and the fail rates.

Example 29. A system comprising one or more chemical product dispensers associated with an establishment; a computing device that receives chemical product dispense event data for a first time frame from the one or more chemical product dispensers; the computing device comprising: one or more processors; and a performance score module including computer readable instructions that, when executed by the one or more processors, cause the one or more processors to determine a chemical product dispense event threshold based on the chemical product dispense event data for the first time frame and determine a chemical product performance score associated with the establishment based on the chemical product dispense event threshold and chemical product dispense event data received for the second time frame, wherein the computing devices further generates, for display on a user computing device, an indication of the determined chemical product performance score.

Example 30. The system of Example 29, further comprising a prediction module including computer readable instructions that, when executed by the one or more processors, cause the one or more processors to determine a predicted number of chemical product dispense events for a second time frame that is subsequent to the first time frame, the prediction module further including computer readable instructions that, when executed by the one or more processors, cause the one or more processors to compare the chemical product dispense event data received for the second time with the predicted number of chemical product dispense events for the second time frame, wherein the computing devices further generates, for display on a user computing device, an indication of the result of the comparison between the chemical product dispense event data received for the second time with the predicted number of chemical product dispense events for the second time frame.

Example 31. The system of Example 29 wherein the one or more chemical product dispensers include one or more hand hygiene product dispensers.

Example 32. The system of Example 29 wherein the one or more chemical product dispensers include one or more sanitizer product dispensers.

Example 33. The system of Example 29 wherein the chemical product dispense event data includes a number of dispense events associated with the one or more chemical product dispensers during the first time frame.

Example 34. The system of Example 29 wherein the chemical product dispense event data includes a total on time associated with the one or more chemical product dispenser during the first time frame.

Example 35. A system comprising one or more chemical product dispensers associated with an establishment; a computing device that receives chemical product dispense event data for a first time frame from the one or more chemical product dispensers; the computing device comprising one or more processors; and a prediction module including computer readable instructions that, when executed by the one or more processors, cause the one or more processors to determine a predicted number of chemical product dispense events for a second time frame that is subsequent to the first time frame, the prediction module further including computer readable instructions that, when executed by the one or more processors, cause the one or more processors to compare the chemical product dispense event data received for the second time with the predicted number of chemical product dispense events for the second time frame, wherein the computing devices further generates, for display on a user computing device, an indication of the result of the comparison between the chemical product dispense event data received for the second time with the predicted number of chemical product dispense events for the second time frame.

Example 36. The system of Example 35, further comprising a performance score module including computer readable instructions that, when executed by the one or more processors, cause the one or more processors to determine a chemical product dispense event threshold based on the chemical product dispense event data for the first time frame and determine a chemical product performance score associated with the establishment based on the chemical product dispense event threshold and chemical product dispense event data received for the second time frame, wherein the computing devices further generates, for display on a user computing device, an indication of the determined chemical product performance score.

Various examples have been described. These and other examples are within the scope of the following claims.

1. A method comprising:
receiving, by a computing device, food safety data associated with a food establishment from one or more data sources;
mapping the food safety data associated with the food establishment to a set of actionable factors;
determining, by the computing device, a food safety performance score associated with the food establishment based on the mapped actionable factors associated with the food establishment;
determining, by the computing device, a predictive risk associated with the food establishment based on the food safety data from the one or more data sources associated with the food establishment; and
generating, for display on a user computing device, an indication of the determined food safety performance score and the determined predictive risk.

2. The method of claim 1 wherein the food safety data includes health department inspection data, observational data, cleaning machine data, and chemical product dispenser data associated with the food establishment.

3. The method of claim 2 wherein observational data include observance of structural, sanitation and maintenance conditions of an establishment.

4. The method of claim 2 wherein observational data includes self-audit data obtained by employees or the food establishment.

5. The method of claim 1 wherein the one or more data sources include a hand hygiene compliance system associated with the food establishment, and wherein the food safety data includes hand hygiene compliance data for the food establishment.

6. The method of claim 1 wherein the food safety predictive risk includes a probability that the food establishment will fail an integer number of standardized health department inspection questions.

7. The method of claim 6 wherein the integer number of standardized health department inspection questions is an integer between 1 and 10.

8. The method of claim 1 wherein the food establishment has an associated food establishment type, and wherein the food safety performance score is relative to other food establishments having the same associated food establishment type.

9. The method of claim 1 further comprising generating a notification to a mobile computing device associated with a user recommending at least one of a training procedure or a product recommendation.

10. The method of claim 1 further comprising generating, for display on a user computing device, a graphical user interface including at least one of a recommended training procedure or a product recommendation.

11. The method of claim 9 or 10 wherein the product recommendation includes one of a cleaning product or a hand washing product.

12. A system comprising:
one or more data sources associated with a food establishment, the one or more data sources monitor parameters related to food safety performance of the food establishment;
a server computing device that receives food safety data from one or more data sources associated with a food establishment, food safety data including monitored parameters related to food safety performance of the food establishment,
the server computing device comprising:
one or more processors;
a mapping that relates the food safety data associated with the food establishment to a set of actionable factors;
a performance score module including computer readable instructions that, when executed by the one or more processors, cause the one or more processors to determine a food safety performance score associated with the food establishment based on the mapped actionable factors associated with the food establishment; and
a predictive risk module including computer readable instructions that, when executed by the one or more processors, cause the one or more processors to determine a predictive risk associated with the food establishment based on the mapped actionable factors associated with the food establishment,
wherein the computing devices further generates, for display on a user computing device, an indication of the determined food safety performance score and the determined predictive risk.

13. The system of claim 12 wherein the food safety data includes health department inspection data, observational data, cleaning machine data, and chemical product dispenser data associated with the food establishment.

14. The system of claim 12 wherein the one or more data sources include a hand hygiene compliance system associated with the food establishment, and wherein the food safety data includes hand hygiene compliance data for the food establishment.

15. The system of claim 12 wherein the food safety predictive risk includes a probability that the food establishment will fail an integer number of standardized health department inspection questions.

16. The method of claim 15 wherein the integer number of standardized health department inspection questions is an integer between 1 and 10.

17. The method of claim 12 further comprising generating a notification to a mobile computing device associated with a user recommending at least one of a training procedure or a product recommendation.

18. The method of claim 12 further comprising generating, for display on a user computing device, a graphical user interface including at least one of a recommended training procedure or a product recommendation.

19. The method of claim 18 wherein the product recommendation includes one of a cleaning product or a hand washing product.

20. A method comprising:
during a training phase: receiving at a server computing device, a plurality of data set training pairs, wherein a first data set of each training pair comprises an actionable factor training data set associated with one of a plurality of food establishments, and wherein a second data set of each training pair comprises a standardized health department inspection questions training data set for the same one of the plurality of food establishments;
determining, by the server computing device, a plurality of probabilistic classifier parameters based on the plurality of data set training pairs, wherein the probabilistic classifier predicts a probability that a food establishment will fail an integer number of the standardized health department inspection questions;
during a prediction phase: receiving, at the probabilistic classifier at the server computing device, a food safety data set associated with a first food establishment;
mapping the food safety data set to a set of actionable factors to create an actionable factor data set associated with the first food establishment;
determining, by the server computing device, a probability that the first food establishment will fail the integer number of the standardized health department inspection questions based on the actionable factor data set and the plurality of probabilistic classifier parameters; and
generating, by the server computing device and for display on a user computing device, an indication of the determined probability.

21. The method of claim 20, wherein the integer number of standardized health department inspection questions is an integer between 1 and 10.

22. The method of claim 20 wherein the probabilistic classifier is a random forest classifier.

23. The method of claim 20 wherein the first data set of each training pair further includes a geospatial training data set associated with the one of the plurality of food establishments.

24. The method of claim 20 wherein the first food establishment is one of the plurality of food establishments in the data set training pairs.

25. The method of claim 20 wherein the first food establishments is not one of the plurality of food establishments in the data set training pairs.

26. The method of claim 20 wherein the indication of the determined probability includes a graphical user interface including the probability that the first food establishment will fail the integer number of standardized health department inspection questions.

27. A method comprising:
obtaining food safety data associated with a food establishment from one or more data sources;
mapping the food safety data associated with the food establishment to a set of actionable factors to create an actionable factor data set associated with the food establishment;
determining, by providing the actionable factor data set to a trained neural network, a probability that the food establishment will fail an integer number of standardized health department questions; and
generating, for display on a user computing device, an indication of the determined probability.

28. A method comprising:
receiving food safety data associated with a food establishment from one or more data sources;
mapping the food safety data associated with a food establishment to a set of actionable factors;
determining a pass rate for each of the actionable factors for a group of similar food establishments;
determining a failure rate for each of the actionable factors for the group of similar food establishments;
applying weights to each of the actionable factors associated with the food establishment; and
determining a food safety performance score based on the actionable factors associated with the food establishment, the weights, the pass rates and the fail rates.

29. A system comprising:
one or more chemical product dispensers associated with an establishment;
a computing device that receives chemical product dispense event data for a first time frame from the one or more chemical product dispensers;
the computing device comprising:
one or more processors; and
a performance score module including computer readable instructions that, when executed by the one or more processors, cause the one or more processors to determine a chemical product dispense event threshold based on the chemical product dispense event data for the first time frame and determine a chemical product performance score associated with the establishment based on the chemical product dispense event threshold and chemical product dispense event data received for the second time frame,
wherein the computing devices further generates, for display on a user computing device, an indication of the determined chemical product performance score.

30. The system of claim 29, further comprising:
a prediction module including computer readable instructions that, when executed by the one or more processors, cause the one or more processors to determine a predicted number of chemical product dispense events for a second time frame that is subsequent to the first time frame,
the prediction module further including computer readable instructions that, when executed by the one or more processors, cause the one or more processors to compare the chemical product dispense event data received for the second time with the predicted number of chemical product dispense events for the second time frame,
wherein the computing devices further generates, for display on a user computing device, an indication of the result of the comparison between the chemical product dispense event data received for the second time with the predicted number of chemical product dispense events for the second time frame.

31. The system of claim 29 wherein the one or more chemical product dispensers include one or more hand hygiene product dispensers.

32. The system of claim 29 wherein the one or more chemical product dispensers include one or more sanitizer product dispensers.

33. The system of claim 29 wherein the chemical product dispense event data includes a number of dispense events associated with the one or more chemical product dispensers during the first time frame.

34. The system of claim 29 wherein the chemical product dispense event data includes a total on time associated with the one or more chemical product dispenser during the first time frame.

35. A system comprising:
one or more chemical product dispensers associated with an establishment;
a computing device that receives chemical product dispense event data for a first time frame from the one or more chemical product dispensers;
the computing device comprising:
one or more processors; and
a prediction module including computer readable instructions that, when executed by the one or more processors, cause the one or more processors to determine a predicted number of chemical product dispense events for a second time frame that is subsequent to the first time frame,
the prediction module further including computer readable instructions that, when executed by the one or more processors, cause the one or more processors to compare the chemical product dispense event data received for the second time with the predicted number of chemical product dispense events for the second time frame,
wherein the computing devices further generates, for display on a user computing device, an indication of the result of the comparison between the chemical product dispense event data received for the second time with the predicted number of chemical product dispense events for the second time frame.

36. The system of claim 35, further comprising:
a performance score module including computer readable instructions that, when executed by the one or more processors, cause the one or more processors to determine a chemical product dispense event threshold based on the chemical product dispense event data for the first time frame and determine a chemical product performance score associated with the establishment based on the chemical product dispense event threshold and chemical product dispense event data received for the second time frame,
wherein the computing devices further generates, for display on a user computing device, an indication of the determined chemical product performance score.
